(19) United States
(12) Patent Application Publication
(10) Pub. No.: US 2026/0125511 A1
(43) Pub. Date: May 7, 2026

(54) POLYMERIZATION OF LACTONES IN POLAR PROTIC SOLVENTS

(71) Applicant: Novomer, Inc., Rochester, NY (US)

(72) Inventors: Christopher A. DeRosa, Rochester, NY (US); Catherine A. Falkner, Rochester, NY (US)

(21) Appl. No.: 19/152,181

(22) PCT Filed: Jan. 25, 2024
(86) PCT No.: PCT/US2024/012880

§ 371 Date: Jul. 30, 2025

Related U.S. Application Data
(60) Provisional application No. 63/442,918, filed on Feb. 2, 2023.

(51) Int. Cl. C08G 63/08; C08G 63/81; C08K 3/32

(52) U.S. Cl. CPC C08G 63/08; C08G 63/81; C08K 3/32; C08K 2003/321

(57) ABSTRACT

A method includes contacting one or more beta-propiolactone monomers and one or more phosphorous compound in a solution under conditions such that a polypropiolactone polymer is formed. The solution comprises one or more polar protic solvents and the one or more phosphorous compounds. The phosphorous compound comprises phosphorous in an ionic form that is either covalently bound to another compound to form a zwitterion or ionically bound to another compound to form a salt.

### FIELD

The present disclosure relates to a method for making polypropiolactone using polar protic solvents.

### BACKGROUND

Beta-lactone monomers are useful to form polypropiolactone polymers. The polypropiolactone polymers are biodegradable and, because of this, have many uses for food and/or beverage packaging. Normally, polypropiolactone polymers are formed by contacting beta-lactone monomers and an initiator in the presence of an aprotic solvent. See, for example, U.S. Pat. No. 11,492,443. However, these solvents can be expensive and undesirable to the environment when disposed of, and the polypropiolactone polymers produced by these techniques can contain side-product or unreacted chemicals that are undesirable in food and/or beverage packaging.

Accordingly, what is needed are techniques to make polypropiolactone free of chemicals considered hazardous to humans. What is needed are techniques to produce polypropiolactone polymers with minimal solvent waste. What is needed are techniques to produce polypropiolactone polymers that can be applied as films and/or coatings.

### SUMMARY

Disclosed herein are methods of forming a polypropiolactone using a polar protic solvent.

Disclosed is a method including contacting one or more beta-propiolactone monomers and one or more phosphorous compounds and optionally one or more carboxylate compounds in a solution under conditions such that a polypropiolactone polymer is formed. The solution includes one or more polar protic solvents and the one or more phosphorous and optionally the one or more carboxylate compounds. The phosphorous compound includes phosphorous in an ionic form that is either covalently bound to another compound to form a zwitterion or ionically bound to another compound to form a salt.

The phosphorous compound may include a phosphonium compound or an anionic phosphate compound. The phosphorous compound may include a compound having the following structure according to formulas I, II, and/or III:

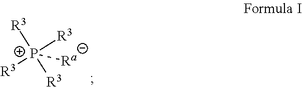

wherein each R³ is separately in each occurrence a group containing one or more carbon atoms wherein two or more of R³ may form one or more aromatic or non-aromatic ring structures which may optionally contain one or more heteroatoms,
wherein the solid lines represent covalent bonds and the dotted lines represent ionic bonds.
wherein R^{a} comprises a phosphate group, a carboxylate group, a carbonate group, an alkoxide group, a halide, or any combination thereof; or

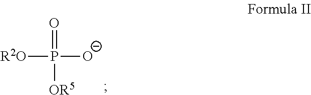

wherein R⁵ is independently a quaternary ammonium group, a phosphonium group, another omnium cation, or any combination thereof; and
wherein R² is defined herein; or

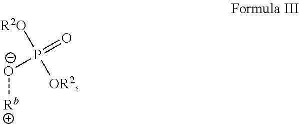

wherein each R² is defined herein; and
wherein R^{b} comprises a quaternary ammonium group, a phosphonium group, another onium cation, or any combination thereof.

The phosphorous compound may include the cationic phosphine compound and an anionic carboxylate having an anionic carboxylate compound having a C₅₋₂₀ alkyl group. The phosphorous compound may include an anionic phosphate and a cationic quaternary ammonium compound. The phosphorous compound may include one or more C₅₋₂₀ alkyl groups covalently bound to a group that is anionic or cationic. The phosphorous compound may include a cation and an anion that are covalently bonded to each other. The phosphorous compound may include a cation and an anion that are ionically bound to each other.

The one or more carboxylate compounds may include a carboxylate compound and a counterion that are dissolvable or dispersible in the polar protic solvent. The one or more carboxylate compounds may comprise a formula according to the following:

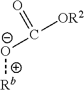

wherein R² and R^{b} are defined herein and the dotted line is defined herein.

The one or more polar protic solvents may be present in a mass percent that is greater than about 90 percent, based on the total mass of the solution when the beta-lactone monomer and the solution are contacted. The one or more polar protic solvents may comprise one or more of water, methanol, ethanol, acetic acid, isopropanol, n-butanol, formic acid, or any combination thereof. The one or more polar protic solvents may comprise water. The beta-lactone monomer may be present in the solution at a mass percent of about 5 percent to about 35 percent based on the total mass of the solution when the beta-lactone monomer and the solution are contacted. The beta-lactone monomer may be present in the solution at a mass percent of about 5 percent to about 25 percent based on the total mass of the solution when the beta-lactone monomer and the solution are contacted. The beta-lactone monomer may be present in the solution at a mass percent of about 5 percent to about 20 percent based on the total mass of the solution when the beta-lactone monomer and the solution are contacted.

The method may further include contacting the one or more phosphorous compounds and the one or more polar protic solvents to form the solution, before the beta-lactone monomer is contacted with the solution. The method may further include contacting the one or more phosphorous compounds, one or more buffers, and the one or more polar protic solvents to form the solution, before the beta-lactone monomer is contacted with the solution. The method may further include contacting the one or more phosphorous compounds, one or more surfactants, and the one or more polar protic solvents to form the solution, before the beta-lactone monomer is contacted with the solution. The method may further include contacting the one or more phosphorous compounds, the one or more buffers, the one or more surfactants, and the one or more polar protic solvents to form the solution, before the beta-lactone monomer is contacted with the solution.

The beta-lactone monomer may be contacted with the solution that comprises one or more buffers configured to retain a pH of the solution greater than 7.0. The beta-lactone monomer is contacted with the solution that comprises one or more surfactants. The beta-lactone monomer may be contacted with the solution that comprises one or more buffers and one or more surfactants. The one or more surfactants may be at least partially miscible with the beta-lactone monomer. The beta-lactone monomer and solution are contacted at a temperature of about 0 degrees Celsius to about 60 degrees Celsius. The step of contacting beta-lactone monomer and the compound in the solution may be performed with agitation for a period of about 12 hours to about 24 hours. Essentially all of the beta-lactone monomer can be converted to the polypropiolactone polymer or a side product in about 3 hours or less. The method may further include contacting the compound and water to form the solution before the step of contacting the beta-lactone monomer and the compound in the solution. The step of contacting the beta-lactone monomer and the compound in the solution may be performed in an environment that is oxygen free.

The method may further include separating the polypropiolactone polymer from the solution. The step of separating may include precipitating the polypropiolactone polymer from the solution; and separating the polypropiolactone polymer from the side products. The step of separating may include precipitating the polypropiolactone polymer from the solution; decanting the solution from the polypropiolactone polymer; washing the polypropiolactone polymer with an alcohol to remove residual of the solution; and drying the polypropiolactone polymer under a vacuum to remove residual of the solution.

The phosphorous compound may be present in an amount sufficient to cause the beta-lactone compound to ring open so that the polypropiolactone polymer is formed and to reduce formation of side products. The phosphorous compound may be present in an amount of 10 ppm to about 200,000 ppm in the solution. The one or more surfactants may be present in an amount that is sufficient to stabilize the solution. The one or more surfactants may be present in an amount of about 10 ppm to about 200,000 ppm in the solution. The one or more buffers may be present in an amount sufficient to retain a pH of the solution above 7.0. The one or more buffers may be present in an amount of about 0.1 g/L to about 10.0 g/L. The side products may be present in an amount of about 10 ppm to about 10,000 ppm in the polypropiolactone polymer. The presence of the side products may not alter a pH of the solution below 7.0.

The phosphorous compound may include a disubstituted phosphate group. The phosphorous compound may include a cationic quaternary ammonium having a C₅₋₂₀ alkyl group. The cationic quaternary ammonium may be covalently bound to the disubstituted phosphate group. The phosphorous compound may include choline that is covalently bound to phosphatidic acid. The phosphorous compound may include phosphatidyl choline. The cationic quaternary ammonium may be ionically bound to the disubstituted phosphate group. The phosphorous compound may include one or more C₅₋₂₀ alkyl groups covalently bound to a phosphorous atom. The phosphorous compound may include two or more C₅₋₂₀ alkyl groups covalently bound to a phosphorous atom. The phosphorous compound may include three or more C₅₋₂₀ alkyl groups covalently bound to a phosphorous atom. The phosphorous compound may include four or more C₅₋₂₀ alkyl groups covalently bound to a phosphorous atom. The phosphorous compound may include an anionic carboxylate compound having an C₁₋₂₀ alkyl group connected with a carbonyl of the carboxylate compound. The phosphorous compound may include a phosphorous cation and an anionic carboxylate compound that are ionically bound. The phosphorous compound may include at least some unsaturation in the one or more C₅₋₂₀ alkyl groups.

The one or more surfactants may include a polymer having repeating groups of alkylene ethers and one or more terminal hydroxyl groups. The alkylene ethers may include one or more of ethylene ethers, propylene ethers, butylene ethers, or any combination thereof. The one or more surfactants may include a polymer that is not ionic. The one or more surfactants may include one or more triblock copolymers. The one or more surfactants may include a poloxamer, a fatty salt, or any combination thereof. The one or more buffers may comprise a monoprotic acid, polyprotic acid, or a combination of both. The one or more buffers may comprise one or more of phosphate buffered saline, bicarbonate, citric acid, boric acid, diethyl barbituric acid, monoalkaline phosphate, or any combination thereof. The side products may comprise acrylic acid, acrylic acid dimer, 3-hydroxypropionic acid, = or any combination thereof.

The polypropiolactone polymer may have a polydispersity index of greater than 1 to about 3.5. The polypropiolactone polymer may have a polydispersity index of greater than 1 to about 1.7. The polypropiolactone polymer may have a number average molecular weight of about 1 kg/mol to about 1000 kg/mol. The polypropiolactone polymer may have a weight average molecular weight about 1 kg/mol to about 2000 kg/mols. The polypropiolactone polymer may be substantially free of beta-lactone monomer and/or acrylic acid. The polypropiolactone polymer may have a melting point of about 70 degrees Celsius to about 130 degrees Celsius. The polypropiolactone polymer may have a crystallization temperature of about 0 degrees Celsius to about 100 degrees Celsius.

The polypropiolactone polymer may have a repeating structure according to the following:

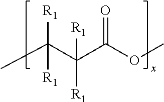

wherein each R¹ is independently selected from one or more of hydrogen, methyl, C₂₋₁₀ alkyl groups, or any combination thereof; and
x is a real number of greater than 1. The variable n may be chosen such that the resulting polymer may have number average molecular weight of from about 500 to 2,000,000 g/mol. x may be 3 to 50,000.

The beta-lactone monomer may have a structure according to the following:

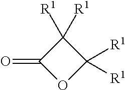

wherein each R¹ is independently selected from one or more of hydrogen, methyl, C₂₋₁₀ alkyl groups, or any combination thereof.

The method may further include contacting carbon monoxide and an epoxide compound to form the beta-lactone monomer. The carbon monoxide and the epoxide compound may be contacted in a presence of a carbonylation catalyst. The epoxide compound may have a structure according to the following:

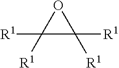

wherein each R¹ is independently selected from one or more of hydrogen, methyl, C₂₋₁₀ alkyl groups, or any combination thereof.

The disclosure includes polymer composition according to the methods disclosed herein, which includes the polypropiolactone polymer having number average molecular weight of about 1000 g/mol to about 200,000 g/mol; polydispersity index of greater than 1 to about 3.5; and side products present in an amount of 50 parts per billion or less.

The present techniques use solvents that produce polypropiolactone polymers that are free of chemicals that are undesirable in food and/or beverage containers. The present techniques utilize solvents that are widely available and can be recycled or easily disposed of after forming the polypropiolactone polymers because the polymer precipitates from the solvent where the monomers react. By precipitating the polypropiolactone polymer from the solvent, the polymer can be readily applied as a film and/or coating directly from the solvent.

### BRIEF DESCRIPTION

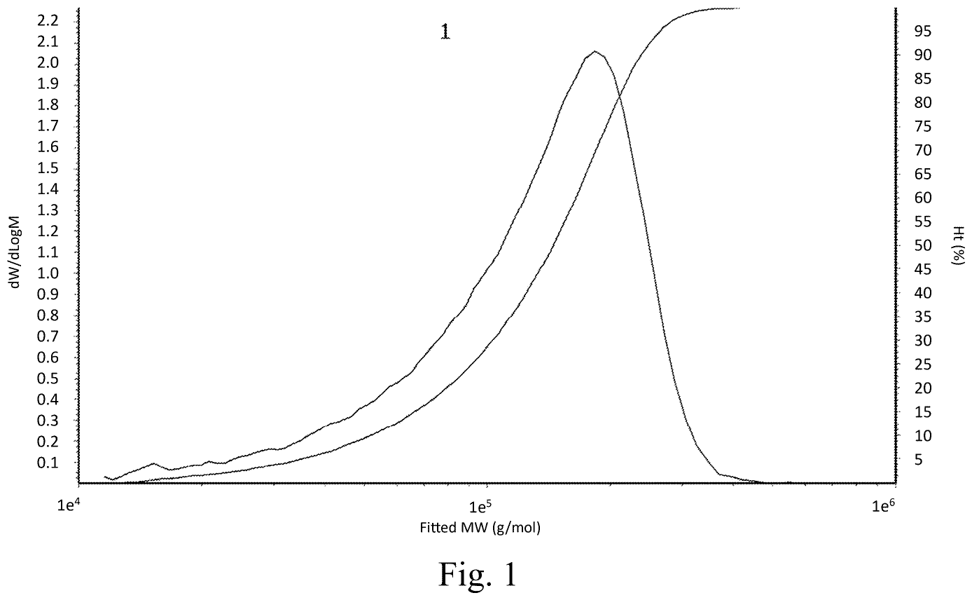

FIG. 1 is Gel Permeation Chromatography (“GPC”) trace of polypropiolactone from example 1.

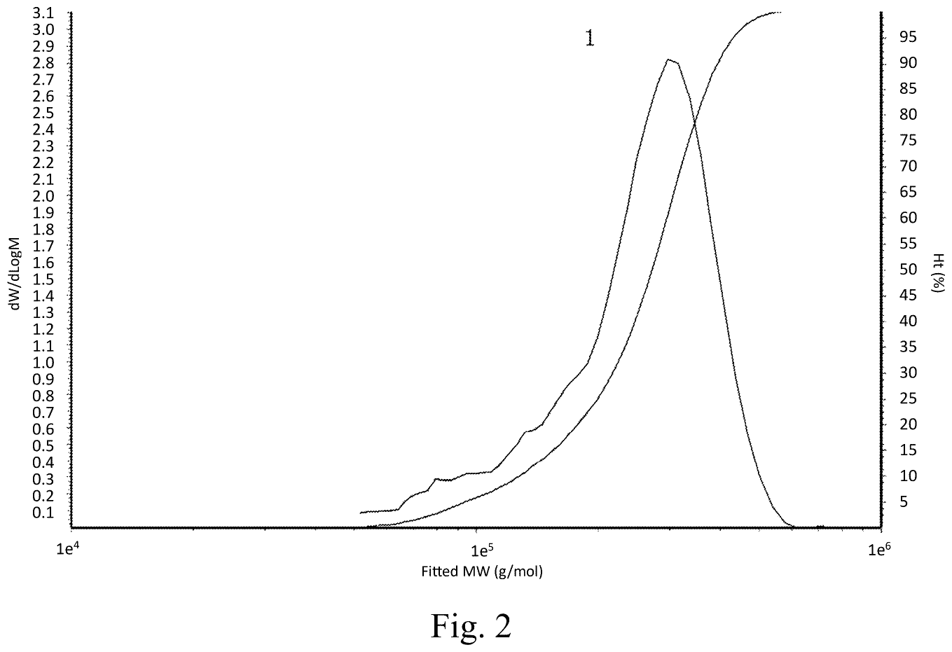

FIG. 2 is GPC trace of polypropiolactone from example 2.

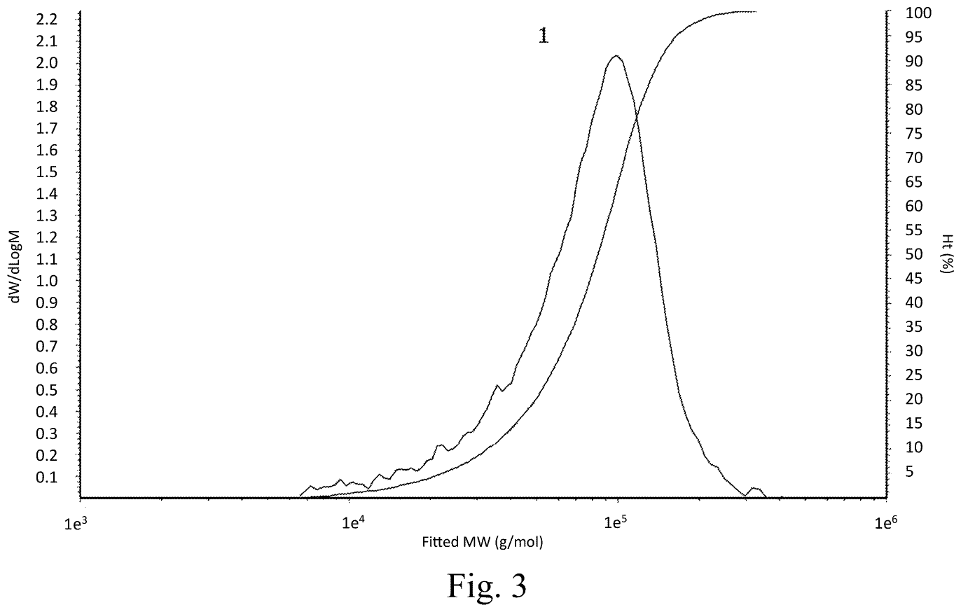

FIG. 3 is GPC trace of polypropiolactone from example 3

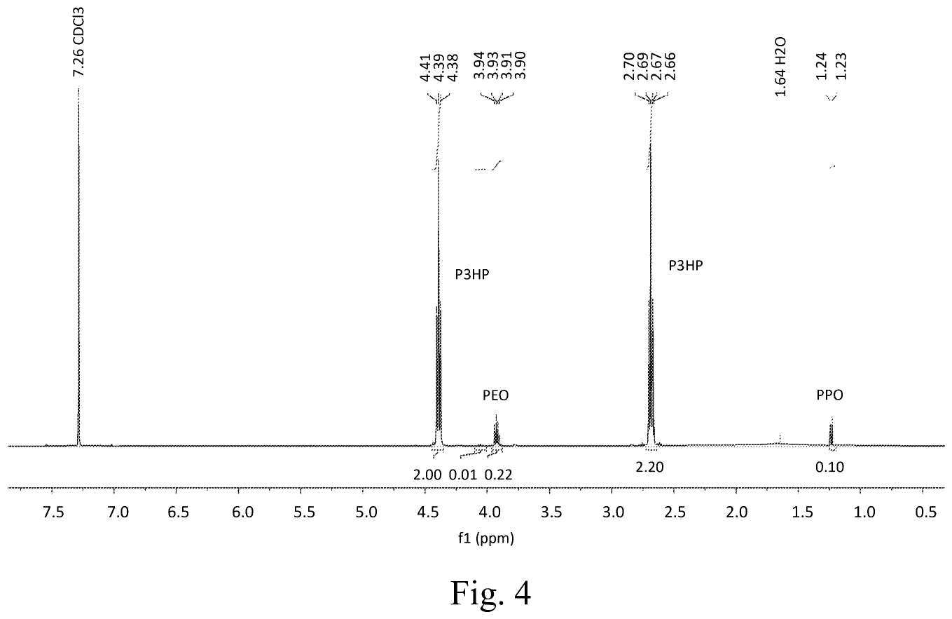

FIG. 4 is ¹H NMR Spectroscopy of polypropiolactone in CDCl₃.

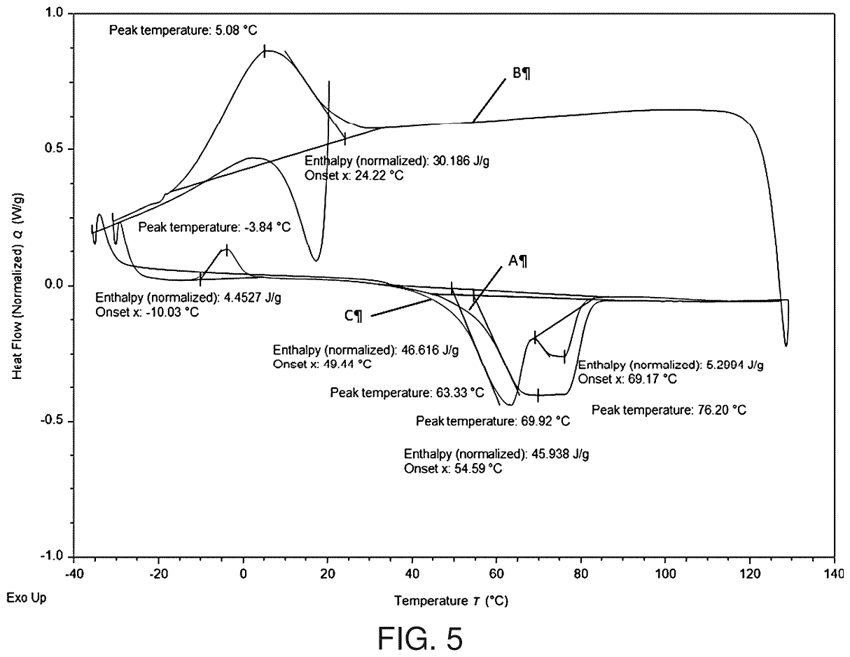

FIG. 5 is Differential Scanning Calorimetry (“DSC”) of a polypropiolactone polymer produced from aqueous polymerization in the presence of PEO-PPO-PEO.

### DETAILED DESCRIPTION

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

One or more as used herein means that at least one, or more than one, of the recited components may be used as disclosed. Residue with respect to an ingredient or reactant used to prepare the polymers or structures disclosed herein means that portion of the ingredient that remains in the polymers or structures after inclusion as a result of the methods disclosed herein. Substantially or essentially all of as used herein means that greater than 90 percent of the referenced parameter, composition, structure or compound meet the defined criteria, greater than 95 percent, greater than 99 percent of the referenced parameter, composition or compound meet the defined criteria, or greater than 99.5 percent of the referenced parameter, composition or compound meet the defined criteria. Substantially or essentially free as used herein means that the reference parameter, composition, structure, or compound contains about 10 percent or less, about 5 percent or less, about 1 percent or less, about 0.5 percent or less, about 0.1 percent or less, or about 0.01 percent or less. Portion as used herein means less than the full amount or quantity of the component in the composition, stream, or both. Precipitate as used herein means a solid compound in a slurry or blend of liquid and solid compounds. The ingredients or products may exist in different states during the processes disclosed, such as solid, liquid, or gaseous state. Phase refers to a portion of a reaction mixture that is not soluble in another part of the reaction mixture. Parts per weight means parts of a component relative to the total weight of the overall composition. Composition or mixture as used herein includes all components in a stream, reactant stream, product stream, slurry, precipitate, solution, liquid, solid, gas, or any combination thereof that are containable within a single vessel. In other words, the mixture may include components that are solid, gaseous (i.e., volatile), and/or liquid when at room temperature (i.e., 25 degrees Celsius) or when exposed to elevated temperatures. Certain polymers disclosed can comprise one or more asymmetric centers, and thus can exist in various stereoisomeric forms, e.g., enantiomers and/or diastereomers. The polymers and compositions thereof may be in the form of an individual enantiomer, diastereomer or geometric isomer, or may be in the form of a mixture of stereoisomers. The polymers disclosed may be enantiopure compounds. Disclosed are mixtures of enantiomers or diastereomers. In certain structures disclosed in this application parts of the structure are connected by a dotted line [symbol] which indicates that the connected structures are ionically bonded together.

Polymers disclosed may comprise one or more crystalline polymorphs, and thus can exist in various crystalline forms.

The term “beta lactone”, as used herein, refers to a substituted or unsubstituted cyclic ester having a four-membered ring comprising an oxygen atom, a carbonyl group and two optionally substituted methylene groups. When unsubstituted, the beta lactone is referred to as propiolactone. Substituted beta lactones include monosubstituted, disubstituted, trisubstituted, and tetrasubstituted beta lactones. Such beta lactones may be further optionally substituted as defined herein. The beta lactones comprise a single lactone moiety. The beta lactones may comprise two or more four-membered cyclic ester moieties.

The term “epoxide”, as used herein, refers to a substituted or unsubstituted oxirane. Such substituted oxiranes include monosubstituted oxiranes, disubstituted oxiranes, trisubstituted oxiranes, and tetrasubstituted oxiranes. Such epoxides may be further optionally substituted as defined herein. The epoxides may comprise a single oxirane moiety. The epoxides comprise two or more oxirane moieties.

The term “polymer”, as used herein, refers to a molecule of high relative molecular mass, the structure of which comprises the multiple repetition of units derived, actually or conceptually, from molecules of low relative molecular mass. The polymer may be comprised of beta lactone monomers (e.g., polypropiolactone) or derived therefrom. Such polymers are also referred to as poly(3-hydroxypropionate). The polymers disclosed may be a copolymer, terpolymer, heteropolymer, block copolymer, or tapered heteropolymer incorporating two or more different monomers.

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic,” as used herein, refers to aliphatic groups wherein one or more carbon atoms are independently replaced by one or more atoms selected from the group consisting of oxygen, sulfur, nitrogen, or phosphorus. Heteroaliphatic groups may be substituted or unsubstituted, branched or unbranched, cyclic or acyclic, and include saturated, unsaturated, or partially unsaturated groups.

The term “unsaturated”, as used herein, means that a moiety has one or more double or triple bonds. The terms “cycloaliphatic”, “carbocycle”, or “carbocyclic”, used alone or as part of a larger moiety, refer to a saturated or partially unsaturated cyclic aliphatic monocyclic or polycyclic ring system, as described herein, having from 3 to 12 members, wherein the aliphatic ring system is optionally substituted as defined below and described herein. Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, norbornyl, adamantyl, and cyclooctadienyl. A cycloaliphatic group may have 3-6 carbons. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring. The term “alkenyl,” as used herein, denotes a monovalent group derived from a straight- or branched-chain aliphatic moiety having at least one carbon-carbon double bond by the removal of a single hydrogen atom. The term “alkynyl,” as used herein, refers to a monovalent group derived from a straight- or branched-chain aliphatic moiety having at least one carbon-carbon triple bond by the removal of a single hydrogen atom. The term “alkoxy”, as used herein refers to an alkyl group, as previously defined, attached to the parent molecule through an oxygen atom. Examples of alkoxy, include but are not limited to, methoxy, ethoxy, propoxy, isopropoxy, n-butoxy, tert-butoxy, neopentoxy, and n-hexoxy. The term “acyl”, as used herein, refers to a carbonyl-containing functionality, e.g., —C(═O)R′, wherein R′ is hydrogen or an optionally substituted aliphatic, heteroaliphatic, heterocyclic, aryl, heteroaryl group, or is a substituted (e.g., with hydrogen or aliphatic, heteroaliphatic, aryl, or heteroaryl moieties) oxygen or nitrogen containing functionality (e.g., forming a carboxylic acid, ester, or amide functionality). The term “acyloxy”, as used here, refers to an acyl group attached to the parent molecule through an oxygen atom. The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring” wherein “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like, where the radical or point of attachment is on the aryl ring.

The terms “heteroaryl” and “heteroar-”, used alone or as part of a larger moiety, e.g., “heteroaralkyl”, or “heteroaralkoxy”, refer to groups having 5 to 14 ring atoms, preferably 5, 6, or 9 ring atoms; having 6, 10, or 14 π electrons shared in a cyclic array; and having, in addition to carbon atoms, from one to five heteroatoms. The term “heteroaryl” may be used interchangeably with the terms “heteroaryl ring” and “heteroaryl group”, any of which terms include rings that are optionally substituted. The term “heteroatom” refers to nitrogen, oxygen, or sulfur, and includes any oxidized form of nitrogen or sulfur, and any quaternized form of a basic nitrogen. A heteroaryl group may be mono- or bicyclic. The term “heteroaralkyl” refers to an alkyl group substituted by a heteroaryl, wherein the alkyl and heteroaryl portions independently are optionally substituted. The term “partially unsaturated” refers to a ring moiety that includes at least one double or triple bond.

As described herein, compounds disclosed may contain “optionally substituted” moieties. The term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned are those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

As used herein the term “alkoxylated” means that one or more functional groups on a molecule (usually the functional group is an alcohol, amine, or carboxylic acid, but is not strictly limited to these) has appended to it a hydroxy-terminated alkyl chain. Alkoxylated compounds may comprise a single alkyl group or they may be oligomeric moieties such as hydroxyl-terminated polyethers. Alkoxylated materials can be derived from the parent compounds by treatment of the functional groups with epoxides. Unless otherwise specified, “a,” “an,” “the,” and “at least one” are used interchangeably and mean one or more than one.

The present techniques allow for formation of polypropiolactone polymer in a polar protic solvent containing a phosphorous compound and optionally one or more carboxylate compounds such that the polypropiolactone polymer precipitates from the solvent once formed. Optionally, a surfactant and/or buffer may be added to control the properties, yields, or formation rates of the polypropiolactone polymer. When precipitated from the solvent, polypropiolactone is essentially free of unreacted starting components, undesirable side products, and/or solvents. Because the present techniques react essentially all of the beta-lactone monomer, the resulting polypropiolactone is safe in products that are configured to be in contact with humans, such as beverage and/or food containers. Additionally, by reacting essentially all of the beta-lactone monomer, the polar protic solvent can be reused.

The reaction between the beta-lactone monomers to form the polypropiolactone polymer may proceed as a polymerization reaction, as shown in scheme 1 below.

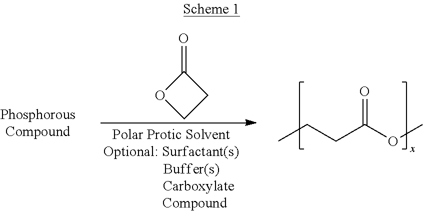

The polymers may on one end of a portion of the chains contain a residue of a phosphate or carboxylate anion covalently bonded to the one end of the polymer chains. The polymers may have a mixture of the residue of a carboxylate anion and a residue of a phosphate anion bonded to the one end of the polymer chains. The other end of a portion of the chains may one or more onium cations.

The polypropiolactone polymer may have any structure of repeating beta-hydroxy units based on the beta-lactone monomer used. The polypropiolactone may have a structure that is a residue of the beta-lactone monomer that are used to form the polypropiolactone. The polypropiolactone may have the following structure:

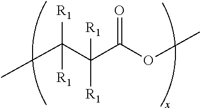

wherein each R¹ is independently in each occurrence hydrogen, a or a carbon containing group which may have one or more hydrogen or fluorine atoms attached to the carbon atoms which may optionally contain one or more heteroatoms and/or substituents; and wherein x is a real number of greater than 1. The variable n may be chosen such that the resulting polymer may have number average molecular weight of from about 500 to 2,000,000 g/mol. x may be 3 to 50,000

The formed polymers may have on the other end of the polymer chains the residue of anionic initiator groups. Such residue may be based on any known initiator groups which may be separately added to the reaction mixture or generated in situ during the polymerization reaction. The residue of the initiator may be formed from the phosphorous compound and/or the carboxylate compound. The residue of the initiator may be one or more residues according to one of the formulas: D,

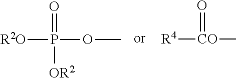

wherein D is the residue of one or more anionic initiators,
wherein R² is separately in each occurrence an optionally substituted group containing one or more carbon atoms;
wherein R⁴ is independently in each occurrence a group containing one or more carbon atoms which may contain a heteroatom or be substituted with a functional group.

The polymers prepared may correspond to the formula

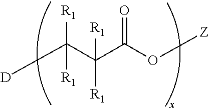

wherein D is the residue of one or more anionic initiators. The polymers prepared may a portion of the polymer chains with a phosphate bonded to one end of the chain. Such polymers may correspond to one of the formulas:

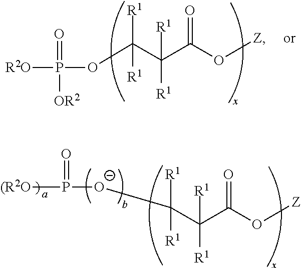

where a is an integer of from 1 to 3 and b is an integer of from 0 to 2. Variable a may be 1, 2 or 3. Variable b may be 0, 1 or 2. The sum of a and b is 3
wherein R¹ and R² are described herein;
where x is described herein; and
Z is independently in each occurrence hydrogen, the residue of an onium cation, and the like. A portion of the polymer chains may have a carboxylate group on the end of some of the chains.

Such polymers may correspond to the formula:

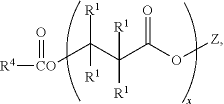

wherein R², R¹, Z and x are as previously described; and
R⁴ is described herein. The polymers prepared may contain polymers with different initiators as described herein.

One or more of R¹ may be a carbon containing group which may have one or more hydrogen or fluorine atoms bonded to carbon atoms, the carbon containing groups may contain one or more of unsaturated groups, electrophilic groups, nucleophilic groups, anionic groups, cationic groups, zwitterion containing groups, hydrophobic groups, hydrophilic groups, halogen atoms, natural minerals, synthetic minerals, carbon-based particles, an ultraviolet active group, a polymer having surfactant properties, and polymerization initiators or reactive heterocyclic rings. The functional groups may be linked to the ring by a linking group (M) which functions to link the functional portion of the groups to the cyclic ring. Exemplary linking groups may be carbon containing groups, ethers, thioethers, polyethers (such as polyalkene ether). One or more of R¹ may be a halogen substituted alkyl group, a sulfonic acid substituted alkyloxy group; an alkyl sulfonate alkyloxy group; alkyl ether substituted alkyl group; a polyalkylene oxide substituted alkyl group, an alkyl ester substituted alkyl group; an alkenyloxy substituted alkyl group; an aryl ester substituted alkyl group; an alkenyl group; a cyano-substituted alkyl group; an alkenyl ester substituted alkyl group; a cycloalkyl substituted alkyl group; an aryl group; a heteroatom containing cycloalkenyl, alkyl ether substituted alkyl group; a hydroxyl substituted alkyl group, a cycloaliphatic substituted alkenyl group; an aryl substituted alkyl group; a haloaryl substituted alkyl group; an aryloxy substituted alkyl group; an alkyl ether substituted alkaryl group; a hetero atom containing cycloaliphatic group substituted alkyl group; a hetero atom containing aryl substituted alkyl group, an alkyl amide substituted alkyl group, an alkenyl substituted cycloaliphatic group; two R¹s may form a cyclic ring, which may optionally contain one or more unsaturated groups; an alkyl group substituted with a beta-lactone group which may optionally be contain one or more ether groups and/or one or more hydroxyl groups; a glycidyl ether group, or a benzocyclobutenyl substituted alkyl group, optionally substituted with one or more ether groups. Beta-lactone corresponds to the formula wherein all the R¹ s are hydrogen. The R¹ s on one carbon atom may both be H while one or both R¹ s on the other carbon atom may be an optionally substituted C₁₋₄₀ aliphatic, optionally substituted C₁₋₂₀ heteroaliphatic, optionally substituted aryl or both R¹ groups may be optionally taken together to form an optionally substituted ring optionally containing one or more heteroatoms. One or two of the R¹ s on different carbon atoms may be alkyl and the others may be hydrogen. The alkyl groups may be C₁-20 alkyl groups, C₁₋₁₂ alkyl groups, C₁₋₈ alkyl groups, C₁₋₄ alkyl groups, wherein the alkyl groups may contain unsaturation, heteroatoms or heteroatom containing functional groups. One or two of the R¹ s on different carbon atoms may be methyl or ethyl and the others may be hydrogen. Two R¹s on the same carbon atom may be methyl while the other R¹s are hydrogen.

R² is separately in each carbon containing group which may contain heteroatoms or one or more unsaturated moieties. R² may be separately in each occurrence one of more alkyl groups, aryl groups, alkaryl groups, aralkyl groups which may contain heteroatoms or one or more unsaturated moieties, wherein two or more of R² may form a cycloalkyl group or cyclic ring comprising one or more aryl groups wherein such groups may contain heteroatoms and/or unsaturated groups. R² may be separately in each occurrence one of more C₁₋₂₀ alkyl groups, C₃₋₂₄ cycloalkyl groups, C₅₋₂₄ aryl groups, C₆₋₂₄ alkaryl groups, C₆₋₂₄ aralkyl groups which may contain heteroatoms or one or more unsaturated moieties. R² may be separately in each occurrence one of more C₁₋₁₂ alkyl groups, C₃₋₁₂ cycloalkyl groups, C₅₋₁₂ aryl groups, C₆₋₁₂ alkaryl groups, C₆₋₁₂ aralkyl groups which may contain heteroatoms or one or more unsaturated moieties. R² may be separately in each occurrence one or more C₁₋₁₂ alkyl groups which may contain heteroatoms or one or more unsaturated moieties. R² may be separately in each occurrence C₁₋₄ alkyl groups which may contain heteroatoms or one or more unsaturated moieties. R² may be separately in each occurrence may be one or more of methyl, ethyl, propyl or butyl groups.

R³ is separately in each occurrence a carbon containing group wherein two or more of R³ may form one or more aromatic or non-aromatic ring structures which may optionally contain one or more heteroatoms. R³ may be separately in each occurrence one of more alkyl groups, aryl groups, alkaryl groups, aralkyl groups which may contain heteroatoms or one or more unsaturated moieties, wherein two or more of R³ may form a cycloalkyl group or cyclic ring comprising one or more aryl groups wherein such groups may contain heteroatoms and/or unsaturated groups. R³ may be separately in each occurrence one of more C₁-20 alkyl groups, C₃₋₂₄ cycloalkyl groups, C₅₋₂₄ aryl groups, C₆₋₂₄ alkaryl groups, C₆₋₂₄ aralkyl groups which may contain heteroatoms or one or more unsaturated moieties. R³ may be separately in each occurrence one of more C₁₋₁₂ alkyl groups, C₃₋₁₂ cycloalkyl groups, C₅₋₁₂ aryl groups, C₆₋₁₂ alkaryl groups, C₆₋₁₂ aralkyl groups which may contain heteroatoms or one or more unsaturated moieties. R³ may be separately in each occurrence one or more C₁₋₁₂ alkyl groups which may contain heteroatoms or one or more unsaturated moieties. R³ may be separately in each occurrence C₁₋₄ alkyl groups which may contain heteroatoms or one or more unsaturated moieties. R³ may be separately in each occurrence may be one or more of methyl, ethyl, propyl or butyl groups.

R⁴ is independently in each occurrence a carbon containing group which may contain a heteroatom or be substituted with a functional group. R⁴ may be separately in each occurrence one of more alkyl groups, aryl groups, alkaryl groups, aralkyl groups which may contain heteroatoms or one or more unsaturated moieties, wherein two or more of R⁴ may form a cycloalkyl group or cyclic ring comprising one or more aryl groups wherein such groups may contain heteroatoms and/or unsaturated groups. R⁴ may be separately in each occurrence one of more C₁₋₂₀ alkyl groups, which may contain heteroatoms or one or more unsaturated moieties. R⁴ may be separately in each occurrence one of more C₁₋₁₂ alkyl groups, which may contain heteroatoms or one or more unsaturated moieties. R⁴ may be separately in each occurrence one or more C₁₋₁₂ alkyl groups which may contain heteroatoms or one or more unsaturated moieties. R⁴ may be separately in each occurrence C₁₋₄ alkyl groups which may contain heteroatoms or one or more unsaturated moieties. R⁴ may be separately in each occurrence may be one or more of methyl, ethyl, propyl or butyl groups. R⁴ may form an acrylate group with the carbonyl oxy moiety to which it is bonded.

The polymer composition formed may have a low polydispersity, for instance a polydispersity index (PDI) of 3.5 or less, 3.0 or less, 2.5 or less, 2.2 or less, 2.0 or less, 1.8 or less, 1.7 or less, 1.6 or less, 1.5 or less, 1.4 or less, 1.3 or less, 1.2 or less, 1.1 or less, 1.05 or less. The polymer composition formed may have a PDI of 1.05 or greater, 1.1 or greater, 1.2 or greater, 1.5 or greater or 2.0 or greater. The PDI values recited refer to that measured by GPC. The PDI values may be calculated without inclusion of GPC peaks arising from oligomers having Mn below about 5,000 g/mol, less than about 4,500, less than about 4,000, less than about 3,500, less than about 3,000, less than about 2,500, less than about 2,000, less than about 1,500, or less than about 1,000 g/mol.

The polymers prepared may have number average molecular weights of greater than about 500 g/mol, 1,000 g/mol, 5,000 g/mol, 10,000 g/mol, 17,000 g/mol, 20,000 g/mol, 25,000 g/mol, 50,000 g/mol, 100,000 g/mol, 200,000 g/mol, 300,000 g/mol or 500,000 g/mol as measured as disclosed herein. The polymers prepared may have number average molecular weights 2,000,000 g/mol or less or 1,000,000 g/mol or less. The polymers prepared may have weight average molecular weights of greater than about 500 g/mol, 1,000 g/mol, 5,000 g/mol, 10,000 g/mol, 17,000 g/mol, 20,000 g/mol, 25,000 g/mol, 50,000 g/mol, 100,000 g/mol, 200,000 g/mol, 300,000 g/mol, 500,000 g/mol, 600,000 g/mol or 700,000 g/mol as measured as disclosed herein. The polymers prepared may have number average molecular weights of 2,000,000 g/mol or less or 1,000,000 g/mol or less. Number and/or weight average molecular weight of the polymer composition refers to that measured by gel permeation chromatography (GPC) using THF as the solvent and referenced to monodisperse polymethyl methacrylate standards.

The polypropiolactone polymers described herein may have a glass transition temperature desirable to be used in products such as food and/or beverage containers or films, coatings, and/or paints. The glass transition temperature may be about −25 degrees Celsius or more, about −20 degrees Celsius or more, or about −15 degrees Celsius or more. The glass transition temperature may be about 0 degrees Celsius or less, about −5 degrees or less, or about −10 degrees Celsius or less. The glass transition temperature may be measured by any known technique. The glass transition temperature may be measured by differential scanning calorimetry (DSC) or dynamic mechanical analysis (DMA).

The polypropiolactone polymers described herein may have a melt temperature desirable to be used in products such as food and/or beverage containers or films, coatings, and/or paints. The melt temperature may be about 60 degrees Celsius or more, about 70 degrees Celsius or more, or about 80 degrees Celsius or more. The melt temperature may be about 120 degrees Celsius or less, about 110 degrees Celsius or less, or about 100 degrees Celsius or less. The melt temperature may be measured by any known technique. The glass transition temperature may be measured by differential scanning calorimetry (DSC) or dynamic mechanical analysis (DMA).

Disclosed are polymers containing the residue of beta-lactones. Functional groups on the beta-lactones may provide functionality to polymers and copolymers prepared from the beta-lactones. The functional groups may function as polymerization initiators, improve adhesion of the polymers to certain substrates or polymer systems, improve the hydrophobic or hydrophilic properties, improve the hardness or scratch resistance, polymerization catalysts, and the like. Polymers and copolymers of beta-lactones may function as intermediate layers in multilayer films, including such films having layers of different polymers. The polymers and copolymers of beta-lactones decompose under certain circumstances and allow the other layers to be easily separated for reuse on recycling. Polymers and copolymers of beta-lactones may function as intermediate layer between coatings of other polymers and a substrate. The polymers and copolymers of beta-lactones decompose under certain circumstances and allow the substrate to be easily separated from the other coating layers for reuse on recycling. The polymers and copolymers of beta-lactones can be used as the outside film layer or coating layer that can be decomposed or such outside layer can be functionalized to provide a desired set of properties to the structure.

The polymerizable composition may comprise a. one or more beta-lactones; and b. one or more salts or zwitterions containing one or more onium cations and one or more phosphate anions.

The beta-lactones which may be in the polymerizable compositions and used to prepare the polymers may be any beta-lactones which polymerize under the conditions defined in this application. The beta-lactones may correspond to the general formula:

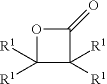

wherein R¹ is as previously described.

Disclosed are homopolymers prepared from the beta-lactones described. Disclosed are copolymers of more than one beta-lactones. Disclosed are compositions comprising a copolymer of one or more beta-lactones disclosed with one or more monomers reactive with the one or more beta-lactones. Disclosed are compositions comprising a copolymer of one or more of the beta-lactones disclosed with one or more monomers reactive with the one or more beta-lactones. Such copolymers may include a plurality of one or more diols, difunctional poly alkyleneoxides, amine terminated polyalkylene oxides, one or more difunctional polyesters, lactams, lactides, cyclic lactones, cyclic anhydrides, cyclic ethers epoxides, episulfides, aziridines, (meth)acrylates, valerolactones, butyrolactone, glycolides, substituted glycolides or polyethers. Such comonomers may be one or more of epoxides, oxiranes, lactams, and lactides. The comonomer may be one or more cyclic anhydrides including succinic anhydride, methyl succinic anhydride, methyl diglycolic anhydride methyl glutaric anhydride, maleic anhydride, phthalic anhydride, citraconic anhydride, trans-1,2-cyclohexanedicarboxylic anhydride. These copolymers may contain units derived from beta propiolactones. The copolymers disclosed may be block copolymers, random copolymers or one or more chains may be grafted to the polymer backbone.

The one or more beta lactones may be:

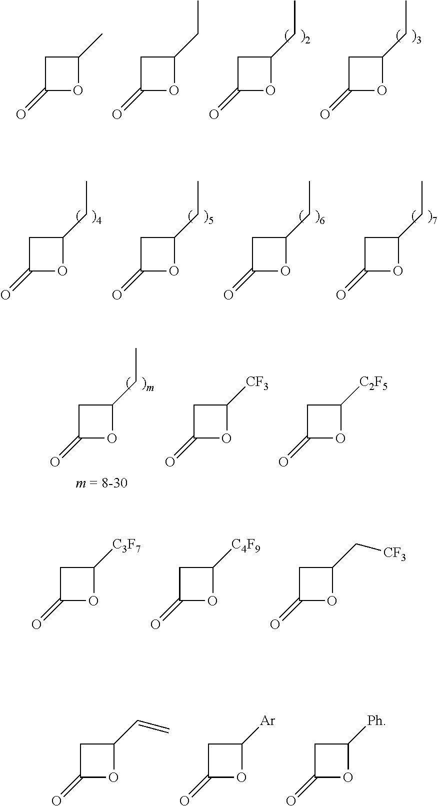

The one or more beta-lactones may be:

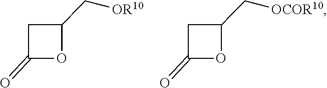

where R¹⁰ may be the same as R¹.

The one or more beta-lactones may be

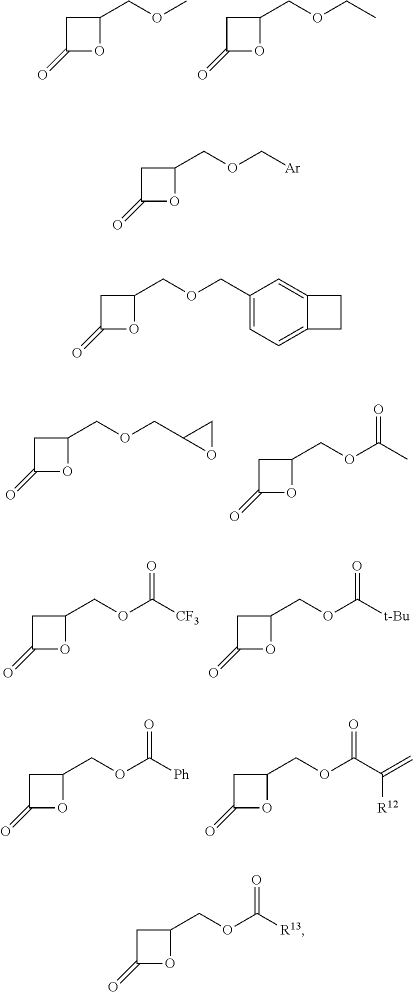

where Ar is any optionally substituted aryl group, R¹² is selected from the group consisting of: —H, optionally substituted C₁₋₂₀ aliphatic, optionally substituted C₁₋₂₀ heteroaliphatic, and optionally substituted aryl, and R¹³ is a fully or partially unsaturated C₂₋₂₀ straight chain aliphatic group.
   The polymers may be prepared from a mixture of beta-propiolactone and pivalolactone:

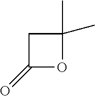

The one or more beta-lactones may be:

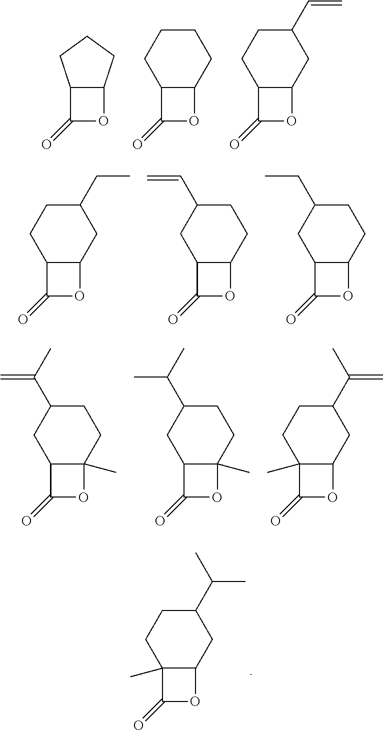

The polymers may be prepared from a mixture of beta propiolactone and a beta lactone of one of the formulas:

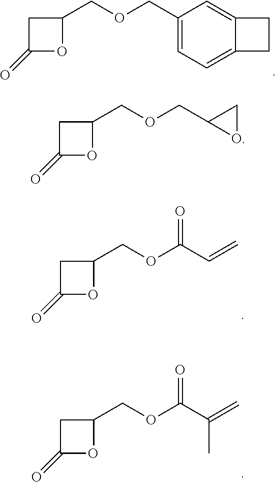

The polymers may be prepared from a mixture of beta-lactones and wherein the beta-lactone is provided as a mixture of regioisomers. Any of the beta-lactone comonomers described above may be provided in combination with their regioisomer(s). Where a beta-lactone comonomer is provided as a regioisomeric mixture, the regioisomer with the largest substituent on the carbon adjacent to the ring oxygen atom is present in molar excess relative to the other regioisomer. The major regioisomer is present in a ratio of 2:1 or greater relative to the minor regioisomer, at least 3:1, at least 5:1, at least 10:1, at least 20:1, at least 30:1, at least 40:1, at least 50:1, or at least 100:1 relative to the minor regioisomer.

The polymers may be prepared from a mixture of beta-lactones and one or more cyclic ethers including tetrahydrofuran, substituted tetrahydrofurans and epoxides. The epoxide may be a substituted epoxide. The epoxide may be one or more of ethylene oxide, propylene oxide, butylene oxide, 4-vinylcyclohexene oxide, 4-ethyl cyclohexene oxide, limonene oxide, a glycidol ether, glycidol ester or cyclohexene oxide. The epoxides may correspond to the formula:

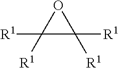

where R¹ is as defined herein. The one or more substituted epoxides may correspond to the formula:

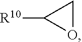

where R¹⁰ may be the same as R¹. The one or more substituted epoxides may be:

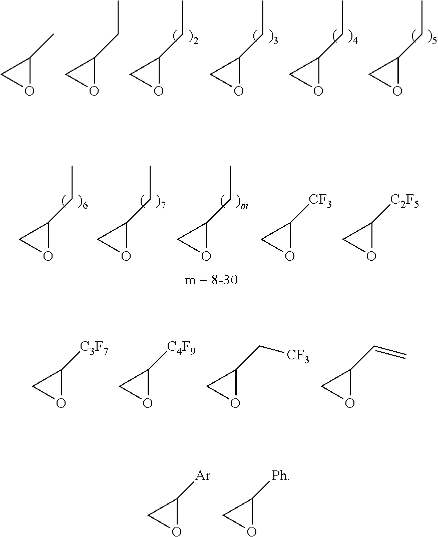

The one or more substituted epoxides may correspond to one of the formulas:

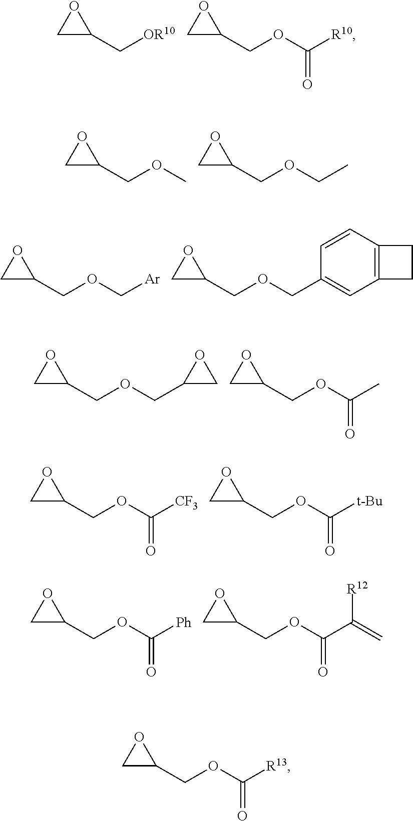

where Ar may be any optionally substituted aryl group;
where R¹⁰ is defined above;
where R¹² may be selected from the group consisting of: —H, optionally substituted C₁₋₂₀ aliphatic, optionally substituted C₁₋₂₀ heteroaliphatic, and optionally substituted aryl, and R¹³ is a fully or partially unsaturated C₂₋₂₀ straight chain aliphatic group, and

The one or more substituted epoxides may correspond to one of the formulas:

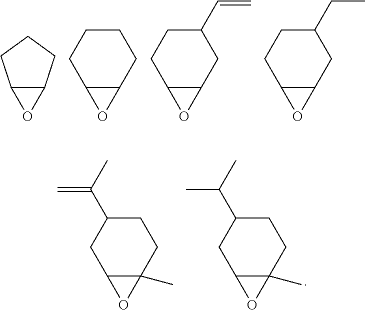

Disclosed are methods of polymerizing beta lactones optionally in combination with one or more additional co-monomers (collectively monomers), using an initiator as described herein. The initiator may, or may not be, covalently attached in the final polymer product.

The polypropiolactone polymers may comprise one or more inhibitors that are configured to reduce the formation of polyacrylic acid before or during the process to form the acrylic acid. The one or more inhibitors may be selected such that polyacrylic acid does not form while beta-lactone is being formed and/or when polypropiolactone is being exposed to heat to form the acrylic acid. The inhibitor may comprise one or more of monomethyl ether hydroquinone, 2-tert-butyl-1,4-benzoquinone, 1,4-benzoquinone, 2,6-di-tert-butylphenol, tert-butylhydroquinone, copper(ii) dibutyldithiocarbamate, 2-[1-(2-hydroxy-3,5-di-tert-pentylphenyl)ethyl]-4,6-di-tert-pentylphenyl acrylate, phenothiazine, 4-methoxyphenol, 4-tert-butylpyrocatechol, 2,6-di-tert-butyl-p-cresol, 6-tert-butyl-2,4-xylenol, 1,1-diphenyl-2-picrylhydrazyl free radical, 2,6-di-tert-butyl-p-cresol, or any combination thereof.

The polypropiolactone polymer may further comprises a residue of the phosphorus compound and/or the surfactant. The polypropiolactone polymer may include any amount of a residue of the phosphorous compound and/or surfactant that does not prohibit use of the polypropiolactone polymer in downstream products like food and/or beverage products. The polypropiolactone polymer may include a mass percent of a residue of the phosphorous compound and/or surfactant of about 5 percent or less, about 3 percent or less, or about 1 percent or less, based on the total mass of the polymer. The polypropiolactone polymer may include a mass percent of a residue of the phosphorous compound and/or surfactant of about 0.01 percent or more, about 0.1 percent or more, or about 0.5 percent or more, based on the total mass of the polymer.

The phosphorus compound may function to support polymerization of a beta-lactone in a polar protic solvent such that a polypropiolactone is formed. The phosphorous compound may be configured as a surfactant, an accelerant, a catalyst, initiator, or a combination thereof.

The phosphorous compound may initiate polymerization between the beta-lactone monomers to form the polypropiolactone polymer. The phosphorous compound may start a process to ring open a beta-lactone monomer to form intermediates that form repeating units derived from ring opened beta-lactones. The phosphorous compound may be any compound known to dissociate or disperse in a polar protic solvent and can form an initiator. The phosphorus compound may form anions sufficient to facilitate formation of a polymer having repeating units derived from ring opened beta-lactone.

The phosphorous compound may be configured as a surfactant having both hydrophobic and hydrophilic groups so that the phosphorous compound can reduce the surface tension between the polar protic solvent and beta-lactone monomers. Hydrophobic groups may be nonpolar. Examples of hydrophobic groups that may be included on in the phosphorous compound include C₅₋₂₀ alkyl, aryl, or alkyl-aryl groups that may optionally include unsaturation. The phosphorous compound may include one or more, two or more, three or more, or four or more hydrophobic groups. Hydrophilic groups may have an electronegatively such that the molecule becomes dissolvable in a polar protic solvent. Examples of hydrophilic groups may include one or more oxygen, phosphorous, and/or nitrogen containing groups.

The phosphorous compound may be configured as a catalyst or accelerant that increases the rate of polymerization in the polar protic solvent such that the polypropiolactone polymer is formed before undesirable amount of beta-lactone degrades into other compounds, such as hydroxy carboxylic acids. The phosphorous compound may be chosen such that the reaction will convert essentially all of the beta-lactone monomer in about 3 hours or less.

The phosphorous compound may have two or more portions with different electronegativity values such that the phosphorous compound facilitates and/or increases the rate of beta-lactone monomer polymerization to polypropiolactone polymers. The phosphorous compound may include at least one portion that is cationic and another portion that is anionic. The anionic and cationic portions may be linked by covalent or ionic bonds. When covalently bonded, the phosphorous compound may be configured or function as a zwitterion. In other words, the phosphorus compound may be a single molecule that includes portions which are cationic and anionic. When the cationic and anionic portions are ionically bound, the phosphorus compound may be configured as a salt that dissociates in the polar protic solvent.

The phosphorous compound may be present in the solution of the method to form the polymer in a mass percent sufficient to cause the beta-lactone compound to ring open so that the polypropiolactone polymer is formed and to reduce formation of side products. The phosphorus compound may be present in the polypropiolactone polymer at a mass percent of about 0.01 percent or more, about 0.1 mass percent or more, or about 0.5 percent or more, based on the total mass of the solution which equals 100%. The phosphorus compound may be present at a concentration of about 5 percent or less, about 3 percent or less, or about 1 percent or less, based on the total mass of the solution which equals 100%.

The polymerizable composition comprises one or more salts or zwitterions containing one or more onium cations and one or more phosphate anions. The phosphate anions may initiate polymerization of the one or more beta-lactones and comonomers polymerizable therewith. The presence of the one or more salts or zwitterions containing one or more one or more onium cations and one or more phosphate anions may facilitate the formation in-situ of carboxylate anions which may initiate polymerization of such monomers. The presence of the one or more salts or zwitterions containing one or more one or more onium cations and one or more phosphate anions may result in the preparation of polymers wherein both of phosphate anions and carboxylate anions initiate polymer chains. The one or more salts or zwitterions of one or more onium cations and one or more phosphate anions may function to catalyze or accelerate the polymerization of the monomers.

The method may comprise any number of different phosphorus compounds sufficient to cause the beta-lactone compound to ring open so that the polypropiolactone polymer is formed and to reduce formation of side products. The solution may comprise one or more, two or more, three or more, four or more, or a plurality of phosphorous compounds. The method may include a phosphorous compound that is configured as a zwitterion and a different phosphorous compound that includes a carboxylate or phosphate anion and an omnium cation that are ionically bound to form a salt.

The carboxylate or phosphate anion and an omnium cation of the phosphorous compound may include any compounds sufficient to facilitate ring opening of the beta-lactone monomer while reducing formation of side products in the polypropiolactone and/or polar protic solvent. As stated herein, the carboxylate or phosphate anion and an omnium cation may be ionically or covalently bound together.

The anion of the phosphorus compound may include one or more of a phosphate, carboxylate, carbonate, an alkoxide, a halogen, or a combination thereof. The anion may include any number of substitutions, such as one or more, two or more, three or more, or four or more substitutions at the oxygen atom of the phosphate or the carbonyl of the carboxylate or carbonate. The anionic portion may be a phosphatidic acid.

The omnium cation may include one or more of a phosphonium compound, quaternary ammonium compound, or any combination thereof. The omnium cation may have one or more, two or more, three or more, or four or more substitutions at the nitrogen and/or phosphorous atoms of the quaternary ammonium compound and/or phosphonium compound.

The phosphorous compound includes a phosphate anion covalently bound to an omnium cation. The omnium cation covalently bound to the phosphate anion may include a quaternary ammonium including one or more C₁₋₂₀ alkyl or aryl groups that optionally include saturation, a phosphonium including one or more C₁₋₂₀ alkyl or aryl groups, or any combination thereof. The omnium cation may additionally include one or more, two or more, or three of more substitutions of hydrogen, C₁₋₂₀ alkyl, aryl, or alkyl-aryl that optionally include unsaturation, or any combination thereof at a nitrogen or phosphorus atom. The omnium cation may include choline.

The phosphorous compound may include a phosphonium compound corresponding to formula I:

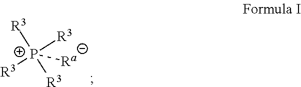

wherein each R³ is separately in each occurrence a carbon containing group wherein two or more of R³ may form one or more aromatic or non-aromatic ring structures which may optionally contain one or more heteroatoms.
Wherein R^{a} comprises a phosphate group, a carboxylate group, a carbonate group, a phosphate group, a halide, or any combination thereof;

The phosphorous compound may include a phosphate compound configured as a zwitterion corresponding to formula II:

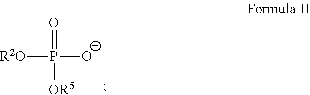

or
wherein R⁵ is independently a quaternary ammonium group, a phosphonium group, another omnium cation, or any combination thereof; and
wherein R² is defined herein;

The phosphorous compound may include a phosphate compound configured as a salt and corresponding to formula III:

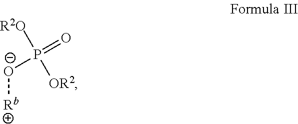

wherein each R² is defined herein; and
wherein R^{b} comprises a quaternary ammonium group, a phosphonium group, another onium cation, or any combination thereof.

The onium cations may be derived from any onium compound which enhances the formation of polymers as disclosed herein. The onium cations may comprise one or more of nitrogen, phosphorus, sulfur, antimony or arsenic. The onium cations may comprise one or more of nitrogen, phosphorus or sulfur. The onium cations may comprise one or more of nitrogen or phosphorus. The onium cations comprise one or more quaternary nitrogen containing cations or quaternary phosphonium containing cations. The onium cations may comprise one or more quaternary nitrogen containing cations or quaternary phosphonium containing cations. The one or more quaternary nitrogen containing cations or quaternary phosphonium cations may comprise one or more tetraalkyl ammonium anions or tetraalkyl phosphonium anions.

The one or more quaternary nitrogen containing cations may be contain four carbon containing groups bonded to the amine nitrogens wherein two or more of the carbon groups may form one or more aromatic or non-aromatic ring structures which may optionally contain one or more heteroatoms. The one or more quaternary nitrogen containing cations may comprise one or more nitrogen-containing heterocycles. The one or more nitrogen-containing heterocycles may comprise optionally substituted pyridinium, imidazolium, pyrrolidinium, or piperidinium moieties. The one or more quaternary nitrogen containing cations may comprise one or more optionally substituted imidazolium. The one or more quaternary nitrogen containing cations may comprise one or more ammonium, amidinium, and guanidinium cations. The one or more quaternary ammonium cations may correspond to the formula

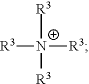

wherein R³ is as defined herein. The one or more guanidinium cations may correspond to the formula:

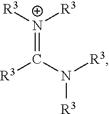

wherein R³ is as defined herein.

The one or more quaternary ammonium cations may be one or more tetraalkyl ammonium anions or an onium cation based on a nitrogen-containing heterocycle such as an optionally substituted pyridinium, imidazolium, pyrrolidinium, or piperidinium. The one or more quaternary ammonium cations may be one or more tetraalkyl ammonium or N-alkyl substituted imidazolium cations. The one or more tetraalkyl ammonium cations may contain one or more of methyl, ethyl, propyl or butyl groups. The butyl groups may be n-butyl or tert-butyl. The one or more tetraalkyl ammonium cations may be tetra methyl ammonium, tetra ethyl ammonium, or tetra tert-butyl ammonium cations.

The one or more quaternary phosphonium cations may be one or more phosphonium cations containing four carbon containing groups The one or more quaternary phosphonium cations may be one or more tetra alkyl phosphonium cations. The one or more quaternary phosphonium cations may correspond to the formula:

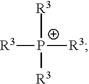

wherein R³ is as defined herein.

The phosphate anion may be any phosphate anion which allows the one or more salts or zwitterions of one or more onium cations and one or more phosphate anion to perform the function as disclosed herein. The phosphate anion may have from one to three onium cations bonded to oxygen groups. The phosphate anion may have from zero to two optionally substituted groups containing nitrogen atoms bonded to oxygens. The phosphate anion may correspond to the formula;

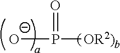

wherein R² is as defined herein, a is an integer of from 1 to 3 and b is an integer of from 0 to 2. Variable a may be 1, 2 or 3. Variable b may be 0, 1 or 2. The sum of a and b is 3. The anion may be a mixture of compounds wherein a and b are different in individual anions in the mixture. The phosphate anion may correspond to the formula;

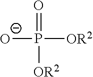

wherein R² is as defined herein.

The one or more salts of one or more onium cations and one or more phosphate anions may be any such salts that provide the properties as disclosed herein. Such salts are formed from the phosphate anions and onium cations disclosed herein and the various anions and cations described herein. The one or more salts of one or more onium cations and one or more phosphate anions may correspond to the formula

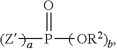

wherein R² is separately in each occurrence an optionally substituted groups containing one or more carbon atoms; Z′ is separately in each occurrence an onium cation as described herein including the variations described herein; a is separately in each occurrence 1, 2 or 3; and b is separately in each occurrence 0, 1 or 2; wherein the sum of a and b is 3.
   The one or more salts of one or more quaternary nitrogen containing cations or quaternary phosphonium cations and one or more phosphate anions corresponds to one of the formulas:

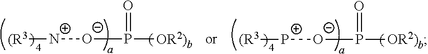

wherein R³, R², a and b are as defined herein. The one or more salts of one or more quaternary nitrogen containing cations or quaternary phosphonium cations and one or more phosphate anions may correspond to one of the formulas

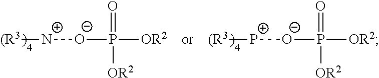

wherein R³ and R² are as defined herein. The one or more salts of one or more one or more quaternary nitrogen containing cations and one or more phosphate anions corresponds to the formula:

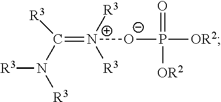

wherein R³ and R² are as defined herein. The one or more salts of one or more one or more quaternary nitrogen containing cations and one or more phosphate anions may corresponds to the formula:

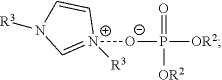

wherein R¹ and R² are as defined herein.

The polymerizable composition may comprise one or more zwitterions containing one or more onium cations, one or more phosphate anions and an optionally substituted carbon group between the anion and the cation with a bond to the anion and cation. The one or more zwitterions may be any of the defined zwitterions that provide the properties as disclosed herein. Such zwitterions are formed from the phosphate anions and onium cations disclosed herein and the various anions and cations described herein. The one or more zwitterions containing one or more onium cations, one or more phosphate anions and an optionally substituted hydrocarbylene moiety between the anions and the cations may correspond to the formula

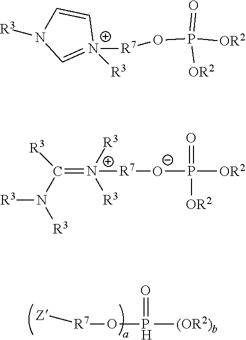

wherein R², R³, Z′, a and b are as defined herein and wherein R⁷ is separately an optionally substituted carbon containing moiety. The zwitterions may correspond to one of the formulas:
The zwitterions may correspond to one of the formulas:

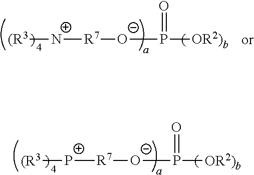

wherein R³, R², R⁷, a and b are as defined herein. The one or more zwitterions of one or more quaternary nitrogen containing cations or quaternary phosphonium cations and one or more phosphate anions may correspond to one of the formulas:

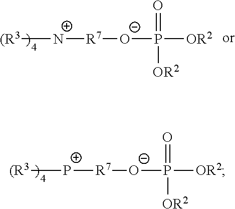

wherein R³, R², R⁷, are as defined herein. The one or more zwitterions containing one or more one or more quaternary nitrogen containing cations and one or more phosphate anions may correspond to the formula:

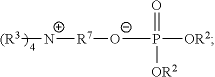

wherein R³, R², R⁷, are as defined herein.
The one or more zwitterions of one or more quaternary nitrogen containing cations and one or more phosphate anions correspond to the formula:

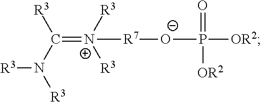

wherein R³, R², R⁷, are as defined herein. The one or more zwitterions of one or more one or more quaternary nitrogen containing cations and one or more phosphate anions may correspond to the formula:

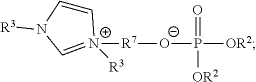

wherein R³, R², R⁷, are as defined herein.
The carboxylate compound may be any compound sufficient to disperse or dissociate in the polar protic solvent and facilitate formation of the propiolactone polymer. The carboxylate compound may comprise any carboxylate group sufficient to facilitate polymerization of one or more beta-lactones such that a polypropiolactone is formed with repeating units derived from ring opened beta-lactones and a residue of the carboxylate compound. The carboxylate compound may include a carboxylate group that is ionically bound with a sufficient counterion such that the carboxylate is dissociable or dispersible in the polar protic solvent. The counterion may be an alkaline earth metal, alkali metal, a phosphonium group, a quaternary ammonium group, another onium group, or any combination thereof. The carboxylate compound may have a structure according to the following:

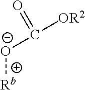

wherein R² and R^{b} are defined herein and the dotted line is defined herein.

The formation of polypropiolactone polymers may be performed in a polar protic solvent. The polar protic solvent may have a polarity the that is at least as polar as water or less. The polar protic solvent may be any solvent that is capable of dissolving beta-lactone and is insoluble with a polypropiolactone having a number average molecular weight of greater than about 2000 g/mol. The polar protic solvent may have any saturation point with the beta-lactone monomer such that at least about 5 percent of the total mass of the solution can be beta-lactone monomer.

The solution may contain any amount of polar protic solvent sufficient to facilitate formation of polypropiolactone when beta-lactone monomers and phosphorous compounds are contacted. The polar protic solvent may be present in a mass percent of about 70 percent or more, about 80 percent or more, or about 90 percent or more, based on the total mass of the solution which sums to 100 percent. The polar protic solvent may be present in a mass percent of about 98 percent or less, about 95 percent or less or about 92 percent or less.

The polar protic solvent may have a boiling point such that the polar protic solvent is separatable from the polypropiolactone polymer without degrading the polypropiolactone from application of heat. The polar protic solvent may have a boiling point that is chosen such that the precipitated polypropiolactone polymer can separated from the polar protic solvent and be applied as a film, coating, and/or paint.

The polar protic solvent may be a solvent comprising an acidic proton. The polar protic solvent may include one or more amine and/or hydroxyl group. The polar protic solvent may be chosen based on whether the solvent is capable of dissolving polypropiolactone, as it is desirable for the polypropiolactone polymer to precipitate from the solution after the polymerization reaction initiates. Examples of polar protic solvents may include one or more of water, methanol, ethanol, acetic acid, isopropanol, n-butanol, formic acid, or any combination thereof.

The surfactant may function to reduce the surface tension between the beta-lactone monomer, the phosphorous compound, polar protic solvent, or any combination thereof. The surfactant may be at least partially miscible with the beta-lactone monomer and the polar protic solvent simultaneously. The surfactant may work in combination with the phosphorous compound to reduce the surface tension between beta-lactone monomer and the polar protic solvent. The surfactant may be absent when the phosphorous compound has the multi-role as a surfactant and accelerant, catalyst, and/or initiator.

The surfactant includes hydrophobic and hydrophilic groups to improve facilitation of beta-lactone monomer polymerization in the polar protic solvent. The surfactant may include the same or different hydrophobic and/or hydrophilic groups compared to the phosphorous compound. Hydrophobic groups may be nonpolar. Examples of hydrophobic groups that may be included on in the phosphorous compound include C₅₋₂₀ alkyl, aryl, or alkyl-aryl groups that may optionally include unsaturation. Hydrophilic groups may have an electronegatively such that the molecule becomes dissolvable in a polar protic solvent. Examples of hydrophilic groups may include one or more oxygen, phosphorous, and/or nitrogen containing groups.

Any surfactant may be used that reduces surface tension between the beta-lactone monomer and the polar protic solvent as the beta-lactone monomer polymerizes to form the polypropiolactone polymer. The surfactant may include one or more of a polymer having repeating groups of alkylene ethers and one or more terminal hydroxyl groups. The surfactant may include one or more alkylene ethers comprising one or more of ethylene ethers, propylene ethers, butylene ethers, or any combination thereof. The surfactant may include a polymer that is not ionic. The surfactant may include one or more triblock copolymers. The surfactant may include poloxamer containing poly(tetrahydrofuran), poly(propylene glycol) and poly(ethylene oxide), or any combination thereof. The solution may include any number of different surfactants sufficient to stabilize the solution. The solution may include one or more, two or more, three or more, four or more, or a combination of different surfactants.

The surfactants may be present in a mass percent that is sufficient to stabilize the solution. The surfactants may be present in a mass percent sufficient to reduce surface tension between the beta-lactone monomer or derivatives thereof and the polar protic solvent.

The solution may include a buffer that is mixed with the polar protic solvent before, after, or during contacting of the beta-lactone, phosphorus buffer, and/or surfactant. The buffer may function to retain the pH of the solution containing the polar protic solvent above 7.0 so that undesirable side products are reduced. Any single or combination of buffers may be used in the solution sufficient to retain a pH above 7.0. The solution may include one or more, two or more, three or more, four or more, or a plurality of buffers. Any buffer sufficient to retain a pH of the solution above 7.0 may be used. The buffer may include one or more of phosphate buffered saline, bicarbonate, citric acid, boric acid, diethyl barbituric acid, monoalkaline phosphate, or any combination thereof.

In the polar solvent, the beta-lactone may reach a saturation point at about 50 mass percent or less, based on the total mass of the solution. The beta-lactone monomer may be present in the polar protic solvent at any mass percent sufficient to form a polypropiolactone polymer when in contact with the phosphorus compound. The beta-lactone monomer may be present at a mass percent of about 2 percent or more, about 5 or more, or about 7 percent or more, based on the total mass of the solution. The beta-lactone monomer may be present at a concentration of about 35 percent or less, about 30 percent or less, about 20 percent or less, or about 10 percent or less, based on the total mass of the solution.

After separating the polypropiolactone polymer from the solution, the polypropiolactone polymer may be essentially free of side products because the side products and unreacted reactants (i.e., beta-lactone monomer and/or hydroxy carboxylic acids) are retained in the solution. Because some of the side products and reactants can be hazardous to humans, separating the polypropiolactone polymer from the solution, via for example precipitation, reduces or avoids the presence of undesirable side products or unreacted reactants in the polypropiolactone polymer and increases the uses of the polymer, such as for beverage and/or food containers or packaging. While the reaction progresses, the phosphorous compounds, buffers, and/or surfactants may reduce the amount of side products formed so that the pH of the solution is not altered below 7.0, yield of polypropiolactone polymer is increased, and/or the properties of the polypropiolactone polymer are increased, such as melt temperature, glass transition temperature, number average molecular weight, weight average molecular weight, or any combination thereof. Side products include one or more of acrylic acid compounds, crotonaldehyde, 3-hydroxy butanone, tetrahydrofuran, or any combination thereof. The side products and/or reactants (i.e., beta-lactone monomer) may be present in the polypropiolactone polymer in an amount that is safe for human contact. The side products and/or reactants may be essentially free from the polypropiolactone polymer. The side products and/or reactants may be present in an amount of about 100 parts per million or less, about 500 parts per billion or less, or about 50 part per billion or less, based on total parts of the polypropiolactone polymer. The side products and/or reactants may be present in an amount of about 1 part per billion or more, about 10 parts per billion or more, or about 25 parts per billion or more.

The present techniques provide for formation of the polypropiolactone polymer by contacting beta-lactone monomers, the phosphorous compound, and the polar protic solvent. The polar protic solvent may first be contacted with the phosphorous compound under conditions such that a solution is formed. Then, the beta-lactone and the solution of polar protic solvent and phosphorous compound are contacted second. The beta-lactone monomers are contacted with the polar protic solvent first to form a solution and the phosphorus compound and the solution of the beta-lactone monomer and the polar protic solvent are contacted second. The beta-lactone monomers, the phosphorus compound, and a polar protic solvent are contacted simultaneously. Optionally, a surfactant and/or buffer may be added to the solution containing the polar protic solvent before, after, or simultaneously as the phosphorus compound and/or beta-lactone monomer.

After contacting the phosphorous compound, the beta-lactone monomer, and the polar protic solvent, an initial amount of polypropiolactone polymer may precipitate shortly afterwards at a number average molecular weight of about 2,000 g/mol or greater. The time period for reacting the reactants is that time needed for the polymer to precipitate. The initial amount of the polypropiolactone polymer may precipitate in about 30 seconds or more, about 5 minutes or more, or about 30 minutes or more. The initial amount of the polypropiolactone polymer may precipitate in about 24 hours or less, about 12 hours or less, or about 3 hours or less.

The beta-lactone may have a half-life in the polar protic solvent that allows for formation of the polypropiolactone in the presence of the phosphorus compound before substantial side products are produces from beta-lactone. The beta-lactone may have a half lite in the polar protic solvent of about 160 minutes or more, about 190 minutes or more, or about 220 minutes of more. The beta-lactone may have a half lite in the polar protic solvent of about 300 minutes or less, about 270 minutes or less, or about 240 minutes of less.

To convert essentially all of the beta-lactone monomer to polypropiolactone polymer before the beta-lactone monomer degrades, the solution of the phosphorous compound, the beta-lactone monomer, and the polar protic solvent may be agitated for a period of time. The agitation may be performed during mixing of the polar protic solvent and phosphorous compound, during combination of the beta-lactone monomer and the solution containing the polar protic solvent and phosphorous compound, and/or throughout the reaction to form the polypropiolactone. The period of time may be about 24 hours or less, about 12 hours or less, or about 3 hours or less. The period of time may be about 30 minutes or more, about 1 hour or more, or about 2 hours or more. The solution may be agitated by any known technique to encourage reaction of the beta-lactone monomer to form the polypropiolactone polymer, such as with stir blades, impellers, rockers, rollers, magnetic stir bars, vortex mixers, stir rods, stir spatulas, or any combination thereof.

The method may be performed in any container sufficient to facilitate the reaction under such conditions that undesirable side products are reduced. The container may be equipped with a heat mechanism to control the temperature of the reaction; agitation devices; or equipment to mitigate or prevent contact of oxygen in the reaction container, as described herein.

The method of contacting the beta-lactone monomer, polar protic solvent and the phosphorous compound may be performed in an environment that is free of oxygen to avoid degradation of the beta-lactone monomer. The method may be performed under a nitrogen or argon stream in a glove box or using a Schlenk line. A solution of the polar protic solvent and the phosphorous compound may be formed outside of the oxygen free environment and subsequently contacted with a beta-lactone monomer under an oxygen free environment.

The beta-lactone monomer and the solution containing the polar protic solvent and the phosphorous compound may be contacted above, below, or equal to ambient temperature (i.e., 25 degrees Celsius). The reaction may proceed at any temperature sufficient for the reaction to proceed at a reasonable rate so that the polypropiolactone polymer precipitates before the expiration of the half-life of the beta-lactone monomer. The beta-lactone monomer and the solution containing the polar protic solvent and the phosphorous compound may be contacted at about 0 degrees Celsius or more, about 15 degrees Celsius or more, or about 25 degrees Celsius or more. The beta-lactone monomer and the solution containing the polar protic solvent and the phosphorous compound may be contacted at about 60 degrees Celsius or less, about 45 degrees Celsius or less, or about 30 degrees Celsius or less.

After essentially all of the beta-lactone is reacted in the polar protic solvent, the polar protic solvent may be separated from the polypropiolactone polymer that has precipitated from the solution. The polar protic solvent may be separated by any known technique for separating two compounds in different phases. The separation technique may be performed via decanting, evaporating, drying, filtrating, sedimentation, or any combination thereof.

Two or more techniques of separating the polar protic solvent from the polypropiolactone polymer may be used in sequence to lower the presence of undesirable compounds that may be in contact with the polypropiolactone polymer. The polar protic solvent may be decanted from the polypropiolactone polymer; the polypropiolactone polymer may be subsequently washed with the same or a different polar protic solvent; and the polypropiolactone polymer may subjected to drying to remove the same or the different polar protic solvent that was used for washing.

The techniques disclosed herein include contacting the beta-lactone monomers, the phosphorous compound, and the polar protic solvents to form and precipitate the polypropiolactone polymer. Subsequently, the solvent can be separated from the polypropiolactone polymer such that the polypropiolactone polymer is in the form of or configured to be applied as a coating, film, and/or paint. One example of an application technique is to apply heat to the solution such that the solvent is evaporated from the polypropiolactone polymer. The heat may be applied at any temperature sufficient to evaporate the solvent. The heat may be applied in temperature of about 80 degrees Celsius or more, about 85 degrees Celsius or more, or about 90 degrees Celsius or more. The heat may be applied at a temperature of about 100 degrees Celsius or less, about 95 degrees Celsius or less, or about 90 degrees Celsius or less. The heat may be applied for any amount of time sufficient to remove all or substantially all of the solvent from the contact with the polypropiolactone polymer. The heat may be applied for about 1 minute or more, about 5 minutes or more, or about 20 minutes or more. The heat may be applied for about 60 minutes or less, about 45 minutes or less, or about 30 minutes or less.

The beta-lactones used to form the described polypropiolactone polymers may be formed by contacting an epoxide and a carbon monoxide under conditions sufficient to form the beta-lactone compounds. Examples of the process conditions and solvents for formation of beta-lactones can be found in at least U.S. Pat. No. 8,445,703, which are incorporated herein by reference. The epoxide and the carbon monoxide may be contacted in the presence of a carbonylation catalyst and/or suitable solvent. The carbonylation catalyst may have any structure that includes a sufficient Lewis acid having a metal center and metal carbonyl cation ionically bound to the Lewis acid. Examples of carbonylation catalysts may include a porphyrin-metal carbonyl catalyst, a salen-metal carbonyl catalyst, or a combination of both. Examples of carbonylation catalysts can additionally be found in U.S. Pat. Nos. 6,852,865, 8,481,756, 10,221,278, and 8,445,703, which are incorporated herein by reference in their entirety.

### ENUMERATED EMBODIMENTS

The following examples are provided to illustrate the invention but are not intended to limit the scope thereof. All parts and percentages are by weight unless otherwise indicated.
Embodiment 1. A method, comprising:
   a) contacting one or more beta-propiolactone monomers and one or more phosphorous compounds and optionally one or more carboxylate compounds in a solution under conditions such that a polypropiolactone polymer is formed,
      wherein the solution comprises one or more polar protic solvents and the one or more phosphorous compounds and optionally the one or more carboxylate compound, and
      wherein the phosphorous compound comprises phosphorous in an ionic form that is either covalently bound to another compound to form a zwitterion or ionically bound to another compound to form a salt.
Embodiment 2. The method of embodiment 1, wherein the phosphorous compound comprises a phosphonium compound or an anionic phosphate compound.
Embodiment 3. The method of embodiment 1, wherein the phosphorous compound comprises one of more of formulas I, II, and/or III:

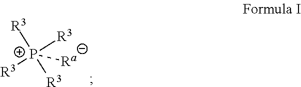

wherein each R³ is separately in each occurrence a hydrocarbyl group wherein two or more of R³ may form one or more aromatic or non-aromatic ring structures which may optionally contain one or more heteroatoms.
wherein R^{a} comprises a phosphate group, a carboxylate group, a carbonate group, an alkoxide group, a halide, or any combination thereof; or

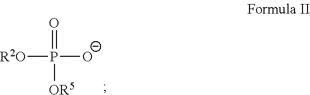

wherein R⁵ is independently a quaternary ammonium group, a phosphonium group, another omnium cation, or any combination thereof; and
wherein R² is defined herein; or

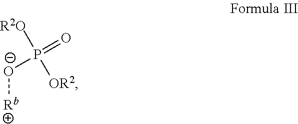

wherein each R² is defined herein; and
wherein the solid lines represent covalent bonds and the dotted lines represent ionic bonds;
wherein R^{b} comprises a quaternary ammonium group, a phosphonium group, another onium cation, or any combination thereof.
Embodiment 4. The method of embodiments 1-3, wherein the phosphorous compound comprises the cationic phosphine compound and an anionic carboxylate having an anionic carboxylate group having a C₅₋₂₀ alkyl group.
Embodiment 5. The method of embodiments 1-3, wherein the phosphorous compound comprises an anionic phosphate and a cationic quaternary ammonium compound.
Embodiment 6. The method of any one embodiments 1-5, wherein the phosphorous compound comprises one or more C₅₋₂₀ alkyl groups covalently bound to a group that is anionic or cationic.
Embodiment 7. The method of any one of embodiments 1 to 6, wherein the phosphorous compound comprises a cation and an anion that are covalently bonded to each other.
Embodiment 8. The method of any one of embodiments 1 to 7, wherein the phosphorous compound comprises a cation and an anion that are ionically bound to each other.
Embodiment 9. The method of any one of the previous embodiments, wherein the one or more carboxylate compounds comprises a carboxylate group and a counterion that are dissolvable or dispersible in the polar protic solvent.
Embodiment 10. The method of any one of the preceding embodiments, wherein the one or more carboxylate compounds comprise a formula according to the following:

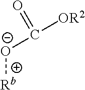

wherein R² and R^{b} are defined herein and the dotted line is defined herein.
Embodiment 11. The method of any one of the preceding embodiments, wherein the one or more polar protic solvents are present in a mass percent that is greater than about 90 percent, based on the total mass of the solution when the beta-lactone monomer and the solution are contacted.
Embodiment 12. The method of any one of the preceding embodiments, wherein the one or more polar protic solvents comprise one or more of water, methanol, ethanol, acetic acid, isopropanol, n-butanol, formic acid, or any combination thereof.
Embodiment 13. The method of any one of the preceding embodiments, wherein the one or more polar protic solvents comprise water.
Embodiment 14. The method of any one of the preceding embodiments, wherein the beta-lactone monomer is present in the solution at a mass percent of about 5 percent to about 35 percent based on the total mass of the solution when the beta-propiolactone monomer and the solution are contacted.
Embodiment 15. The method of any one of the preceding embodiments, wherein the beta-lactone monomer is present in the solution at a mass percent of about 5 percent to about 25 percent based on the total mass of the solution when the beta-propiolactone monomer and the solution are contacted.
Embodiment 16. The method of any one of the preceding embodiments, wherein the beta-propiolactone monomer is present in the solution at a mass percent of about 5 percent to about 20 percent based on the total mass of the solution when the beta-propiolactone monomer and the solution are contacted.
Embodiment 17. The method of any one of the preceding embodiments, further comprising:
   a) contacting the one or more phosphorous compounds and the one or more polar protic solvents to form the solution, before the beta-lactone monomer is contacted with the solution.
Embodiment 18. The method of any one of the preceding embodiments, further comprising:
   a) contacting the one or more phosphorous compounds, one or more buffers, and the one or more polar protic solvents to form the solution, before the beta-lactone monomer is contacted with the solution.
Embodiment 19. The method of any one of the preceding embodiments, further comprising:
   a) contacting the one or more phosphorous compounds, one or more surfactants, and the one or more polar protic solvents to form the solution, before the beta-lactone monomer is contacted with the solution.
Embodiment 20. The method of any one of the preceding embodiments, further comprising:
   a) contacting the one or more phosphorous compounds, the one or more buffers, the one or more surfactants, and the one or more polar protic solvents to form the solution, before the beta-lactone monomer is contacted with the solution.
Embodiment 21. The method of any one of the preceding embodiments, wherein beta-lactone compound is contacted with the solution that comprises one or more buffers configured to retain a pH of the solution greater than 7.0.
Embodiment 22. The method of any one of the preceding embodiments, wherein the beta-lactone monomer is contacted with the solution that comprises one or more surfactants.
Embodiment 23. The method of any one of the preceding embodiments, wherein the beta-lactone monomer is contacted with the solution that comprises one or more buffers and one or more surfactants.
Embodiment 24. The method of any one of the preceding embodiments, wherein the one or more surfactants are at least partially miscible with the beta-lactone monomer.
Embodiment 25. The method of any one of the preceding embodiments, wherein the beta-lactone and solution are contacted at a temperature of about 0 degrees Celsius to about 60 degrees Celsius.
Embodiment 26. The method of any one of the preceding embodiments, wherein the step of contacting beta-lactone monomer and the compound in the solution is performed with agitation for a period of about 12 hours to about 24 hours.
Embodiment 27. The method of any one of the preceding embodiments, wherein essentially all of the beta-lactone monomer is converted to the polypropiolactone polymer or a side product in about 3 hours or less.
Embodiment 28. The method of any one of the preceding embodiments, further comprising:
   a) contacting the compound and water to form the solution, before the step of contacting the beta-lactone monomer and the compound in the solution.
Embodiment 29. The method of any one of the preceding embodiments, wherein the step of contacting the beta-lactone monomer and the compound in the solution is performed in an environment that is oxygen free.
Embodiment 30. The method of any one of the preceding embodiments, further comprising:
   a) separating the polypropiolactone polymer from the solution.
Embodiment 31. The method of any one of the preceding embodiments, further comprising:
   a) precipitating the polypropiolactone polymer from the solution; and
   b) separating the polypropiolactone polymer from the side products.
Embodiment 32. The method of any one of the preceding embodiments, wherein the step of separating the polypropiolactone polymer from the solution comprises:
   a) precipitating the polypropiolactone polymer from the solution;
   b) decanting the solution from the polypropiolactone polymer;
   c) washing the polypropiolactone polymer with an alcohol to remove residual of the solution; and
   d) drying the polypropiolactone polymer under a vacuum to remove residual of the solution.
Embodiment 33. The method of any one of the preceding embodiments, wherein the phosphorous compound is present in an amount sufficient to cause the beta-lactone compound to ring open so that the polypropiolactone polymer is formed and to reduce formation of side products.
Embodiment 34. The method of any one of the preceding embodiments, wherein the phosphorous compound is present in an amount of 10 ppm to about 200,000 ppm in the solution. T
Embodiment 35. The method of any one of the preceding embodiments, wherein the one or more surfactants are present in an amount that is sufficient to stabilize the solution.
Embodiment 36. The method of any one of the preceding embodiments, wherein the one or more surfactants are present in an amount of about 10 ppm to about 200,000 ppm in the solution.
Embodiment 37. The method of any one of the preceding embodiments, wherein the one or more buffers are present in an amount sufficient to retain a pH of the solution above 7.0.
Embodiment 38. The method of any one of the preceding embodiments, wherein the one or more buffers are present in an amount of about 0.1 g/L to about 10.0 g/L.
Embodiment 39. The method of any one of the preceding embodiments, wherein the side products are present in an amount of about 10 ppm to about 10,000 ppm in the polypropiolactone polymer.
Embodiment 40. The method of any one of the preceding embodiments, wherein a presence of the side products does not alter a pH of the solution below 7.0.
Embodiment 41. The method of any one of the preceding embodiments, wherein the phosphorous compound comprises a disubstituted phosphate group.
Embodiment 42. The method of any one of the preceding embodiments, wherein the phosphorous compound comprises a cationic quaternary ammonium having a C₅₋₂₀ alkyl group.
Embodiment 43. The method of any one of the preceding embodiments, wherein the cationic quaternary ammonium is covalently bound to the disubstituted phosphate group.
Embodiment 44. The method of any one of the preceding embodiments, wherein the phosphorous compound comprises choline that is covalently bound to phosphatidic acid.
Embodiment 45. The method of any one of the preceding embodiments, wherein the phosphorous compound comprises phosphatidyl choline.
Embodiment 46. The method of any one of the preceding embodiments, wherein the cationic quaternary ammonium is ionically bound to the disubstituted phosphate group.
Embodiment 47. The method of any one of the preceding embodiments, wherein the phosphorous compound comprises one or more C₅₋₂₀ alkyl groups covalently bound to a phosphorous atom.
Embodiment 48. The method of any one of the preceding embodiments, wherein the phosphorous compound comprises two or more C₅₋₂₀ alkyl groups covalently bound to a phosphorous atom.
Embodiment 49. The method of any one of the preceding embodiments, wherein the phosphorous compound comprises three or more C₅₋₂₀ alkyl groups covalently bound to a phosphorous atom.
Embodiment 50. The method of any one of the preceding embodiments, wherein the phosphorous compound comprises four or more C₅₋₂₀ alkyl groups covalently bound to a phosphorous atom.
Embodiment 51. The method of any one of the preceding embodiments, wherein the phosphorous compound comprises an anionic carboxylate compound having an C₁₋₂₀ alkyl group connected with a carbonyl of the carboxylate compound.
Embodiment 52. The method of any one of the preceding embodiments, wherein the phosphorous compound comprises a phosphorous cation and an anionic carboxylate compound that are ionically bound.
Embodiment 53. The method of any one of the preceding, wherein the phosphorous compound includes at least some unsaturation in the one or more C₅₋₂₀ alkyl groups.
Embodiment 54. The method of any one of the preceding embodiments, wherein the one or more surfactants comprise a polymer having repeating groups of alkylene ethers and one or more terminal hydroxyl groups.
Embodiment 55. The method of any one of the preceding embodiments, wherein the alkylene ethers comprise one or more of ethylene ethers, propylene ethers, butylene ethers, or any combination thereof.
Embodiment 56. The method of any one of the preceding embodiments, wherein the one or more surfactants comprise a polymer that is not ionic.
Embodiment 57. The method of any one of the preceding embodiments, wherein the one or more surfactants comprise one or more triblock copolymers.
Embodiment 58. The method of any one of the preceding embodiments, wherein the one or more surfactants comprise poloxamer, a fatty salt, or any combination thereof.
Embodiment 59. The method of any one of the preceding embodiments, wherein the one or more buffers comprise a monoprotic acid, polyprotic acid, or a combination of both.
Embodiment 60. The method of any one of the preceding embodiments, wherein the one or more buffers comprise one or more of phosphate buffered saline, bicarbonate, citric acid, boric acid, diethyl barbituric acid, monoalkaline phosphate, or any combination thereof.
Embodiment 61. The method of any one of the preceding embodiments, wherein the side products comprise acrylic acid, acrylic acid dimer, 3-hydroxypropionic acid, or any combination thereof.
Embodiment 62. The method of any one of the preceding embodiments, wherein the polypropiolactone polymer has a polydispersity index of greater than 1 to about 3.5.
Embodiment 63. The method of any one of the preceding embodiments, wherein the polypropiolactone polymer has a polydispersity index of greater than 1 to about 1.7.
Embodiment 64. The method of any one of the preceding embodiments, wherein the polypropiolactone polymer has a number average molecular weight of about 1 kg/mol to about 1000 kg/mol.
Embodiment 65. The method of any one of the preceding embodiments, wherein the polypropiolactone polymer has a weight average molecular weight about 1 kg/mol to about 2000 kg/mol.
Embodiment 66. The method of any one of the preceding embodiments, wherein the polypropiolactone polymer is substantially free of beta-lactone monomer and/or acrylic acid.
Embodiment 67. The method of any one of the preceding embodiments, wherein the polypropiolactone polymer has a melting point of about 70 degrees Celsius to about 130 degrees Celsius.
Embodiment 68. The method of any one of the preceding embodiments, wherein the polypropiolactone polymer has crystallization temperature of about 0 degrees Celsius to about 100 degrees Celsius.
Embodiment 69. The method of any one of the preceding embodiments, wherein the polypropiolactone polymer has a repeating structure according to the following:

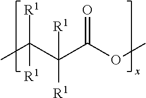

wherein each R¹ is independently selected from one or more of hydrogen, methyl, C₂₋₁₀ alkyl groups, or any combination thereof; and
wherein x is a real number of greater than 1 to 50,000.
Embodiment 70. The method of any one of the preceding embodiments, wherein the beta-lactone monomer has a structure according to the following:

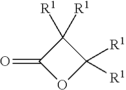

wherein each R¹ is independently selected from one or more of hydrogen, methyl, C₂₋₁₀ alkyl groups, or any combination thereof.
Embodiment 71. The method of any one of the preceding embodiments, further comprising:
   a) contacting carbon monoxide and an epoxide compound to form the beta-lactone monomer.
Embodiment 72. The method of embodiment 71, wherein the carbon monoxide and the epoxide compound are contacted in a presence of a carbonylation catalyst.
Embodiment 73. The method of embodiments 71 or 72, wherein the epoxide compound has a structure according to the following:

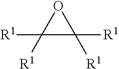

wherein each R¹ is independently selected from one or more of hydrogen, methyl, C₂₋₁₀ alkyl groups, or any combination thereof.
Embodiment 74. A polymer composition according to the method of any one of the preceding embodiments, comprising the polypropiolactone polymer having:
   a) Number average molecular weight of about 1000 g/mol to about 200,000 g/mol;
   b) PDI of greater than 1 to about 3.5; and
   c) side products present in an amount of 50 parts per billion or less.

### EXAMPLES

The following examples are provided to illustrate the disclosure but are not intended to limit the scope thereof.

GPC is performed on an Agilent 1260 Infinity II HPLC system equipped with two PLgel 300×7.5 mm (PL111-6500) size exclusion columns and a multi-detector [refractive index and viscometer]. The GPC is performed in chloroform solvent at a rate of 1.0 mL/min and maintained at 40° C. Polymer molar masses is determined using a conventional calibration curve of the RI signal generated with monodisperse polymethyl methacrylate (“PMMA”) polymer standards. PMMA standards range from 500 g/mol to 2,000,000 g/mol (Agilent EasiVial; Part No: PL2020-0201). The polypropiolactone polymer is dissolved in HPLC grade chloroform [˜5 mg/mL], then filtered through 0.2 mm PVDF filter

¹H NMR spectroscopy is performed of a 400 MHz Varian INOVA spectrometer. The spectrum is referenced to protio-chloroform (7.26 ppm). The polypropiolactone polymer sample is dissolved in CDCl₃ (99.8% deuterated; Cambridge Isotope) at a 10 mg/mL concentration.

Differential scanning calorimetry (“DSC”) is performed on a TA instrument Q20-series differential scanning calorimeter under N_{2(g)} at a ramp rate of 10° C.×min⁻¹. The thermal history of the polymer is as follows: the polymer was melted at 130° C. to erase thermal and solvent memory and cooled to −30° C. at a rate of 10° C.×min⁻¹. The sample is heated again at a ramp rate of 10° C.×min⁻¹ to 130° C., then rapidly cooled to −30° C. [melt-quenching]. The polymer is then re-heated to 130° C. [ramp rate of 10° C.×min⁻¹].

### Example 1

In a glovebox, 100 μL of beta propiolactone monomer is added to a 2 mL crimp-top gas chromatography vial. The vial is sealed under a nitrogen gas atmosphere. Outside the glovebox, an aqueous solution containing alpha lecithin [125 mg; 0.12 mass percent] and pluronics [300 mg; 0.3 mass percent] is prepared in 100 mL of phosphate buffered saline [PBS]. Under a nitrogen gas atmosphere, about 900 μL of the solution is added to the beta propiolactone monomer, and the solution is stirred gently. A white solid precipitates within minutes. The solution is allowed to stir overnight to fully consume the beta propiolactone monomer. The water is decanted off, and the polymer is washed with isopropanol three times [1 mL×3]. The resulting solid is dried en vacuo overnight to yield 95 mg of polypropiolactone polymer. [95%; Mn (GPC)=98,000 g/mol, PDI=1.5].

### Example 2

In a glovebox, 200 μL of beta propiolactone monomer is added to a 2 mL crimp-top vial. The vial is sealed under a nitrogen gas atmosphere. Outside the glovebox, an aqueous solution containing octadecyl-trimethylammonium dimethyl phosphate [ODTMA DMP][150 mg; 0.15 mass percent] and pluronics [300 mg; 0.3 mass percent] is prepared in 100 mL of deionized water. Under a nitrogen gas atmosphere, about 800 μL of the solution is added to the beta propiolactone monomer, and the solution is stirred gently. A white solid precipitates within minutes. The solution is allowed to stir overnight to fully consume the beta propiolactone monomer. The water is decanted off, and the polymer is washed with isopropanol three times [1 mL×3]. The resulting solid is dried en vacuo overnight to yield 53 mg of a polypropiolactone polymer [27%; Mn (GPC)=218,000 g/mol, PDI=1.2].

### Example 3

In a glovebox, 200 μL of beta propiolactone monomer is added to a 2 mL crimp-top vial. The vial is sealed under a nitrogen gas atmosphere. Outside the glovebox, an aqueous solution containing trihexyl(tetradecyl)phosphonium decanoate [THTDPD][150 mg; 0.15 mass percent] was prepared in 100 mL of deionized water. Under a nitrogen gas atmosphere, about 800 μL of the solution is added to the beta propiolactone monomer, and the solution is stirred gently. A white solid precipitates within minutes. The solution is allowed to stir overnight to fully consume the beta propiolactone monomer. The water is decanted off, and the polymer is washed with isopropanol three times [1 mL×3]. The resulting solid is dried en vacuo overnight to yield 13 mg [7%; Mn (GPC)=59,300 g/mol, PDI=1.5].

### Results

FIG. 1 is Gel Permeation Chromatography (“GPC”) trace of polypropiolactone from example 1.

FIG. 2 is GPC trace of polypropiolactone from example 2.

FIG. 3 is GPC trace of polypropiolactone from example 3.

FIG. 4 is 1H NMR Spectroscopy of polypropiolactone in CDCl3.

FIG. 5 is Differential Scanning Calorimetry of a polypropiolactone polymer produced from aqueous polymerization in the presence of PEO-PPO-PEO. First heat cycle [Line A; 10° C./min under N₂(g)]. Cooling cycle [Line B; 10° C./min under N₂(g)]. Second heat cycle [Line C; 10° C./min under N₂(g)].

Examples 1-3 [see above for experimental set up and preliminary results] describe the process of aqueous polymerization of beta propiolactone monomers. The structures of each of the compounds used in the polymerization of the beta propiolactone monomers are shown below in Scheme 1. The results of each example are shown in Table 1. In general, yields are low to high [7-95%]. Surprisingly, the isolated polymer is a high molar mass with low dispersity [Mₙ>50 kDa, PDI <1.5; FIG. 1]. ¹H NMR spectroscopy confirms the structure of poly(3-hydroxypropionic acid) [FIG. 34]. Thermal properties suggest the surfactants used plasticize the polymer, as a depression of melting point is observed for the final polymer [FIG. 5].

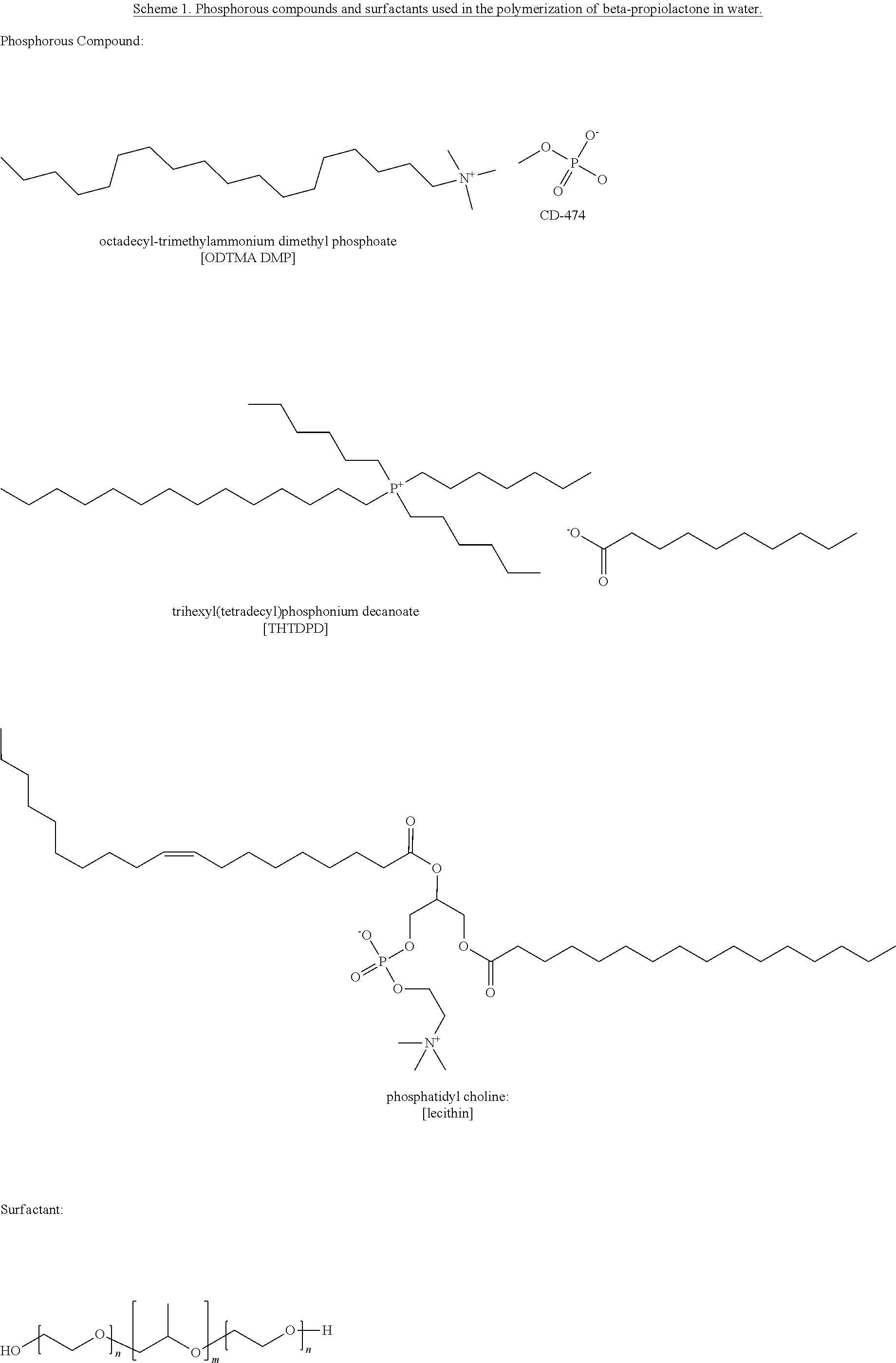

TABLE 1
Aqueous Polymerization of beta-propiolactone

| | | | bPL^{c} | | Mₙ^{e} | | Tₘ^{f} | T_{c}^{f} |
|---|---|---|---|---|---|---|---|---|
| Example | Initiator^{a} | Additives^{b} | [%] | Yield^{d} | [kg/mol] | PDI^{e} | [° C.] | [° C.] |
| 1 | Lecithin | Pluronics in PBS | 11 | 95 | 98 | 1.5 | 63 | 5 |
| | | | | | | | [41] | [30] |
| | | | | | | | 69 | |
| | | | | | | | [5] | |
| 2 | ODTMA | Pluronics in | 19 | 27 | 218 | 1.2 | — | — |
| | DMP | deionized water | | | | | | |
| 3 | THTDPD | deionized water | 19 | 7 | 59 | 1.5 | — | — |

^{a}Initiator is 0.15 mass percent in aqueous solution
^{b}Pluronics [0.3 mass percent in water or PBS solution]
^{c}Mass percent of bPL in solution
^{d}Mass yield of P3HP solid
^{e}Number average molar mass [Mₙ] and dispersity index [PDI = M_{w}/Mₙ] determined by GPC [CHCl₃ @ 1.0 mL/min versus PMMA standards]
^{f}Melting point [Tₘ] and crystallization temperature [T_{c}] determined by differential scanning calorimetry [DSC; 10° C./min under N_{2(g)}].

1. A method, comprising:
a) contacting one or more beta-propiolactone monomers and one or more phosphorous compounds and optionally one or more carboxylate compounds in a solution under conditions such that a polypropiolactone polymer is formed,
wherein the solution comprises one or more polar protic solvents and the one or more phosphorous compounds and optionally the one or more carboxylate compounds, and
wherein the phosphorous compound comprises phosphorous in an ionic form that is either covalently bound to another compound to form a zwitterion or ionically bound to another compound to form a salt.

2. The method of claim 1, wherein the phosphorous compound comprises a phosphonium compound or an anionic phosphate compound.

3. The method of claim 1, wherein the phosphorous compound comprises one of more of formulas I, II, and/or III: 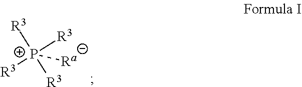
wherein each R³ is separately in each occurrence a hydrocarbyl group wherein two or more of R³ may form one or more aromatic or non-aromatic ring structures which may optionally contain one or more heteroatoms.
wherein R^{a} comprises a phosphate group, a carboxylate group, a carbonate group, an alkoxide group, a halide, or any combination thereof; or 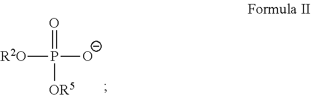
wherein R⁵ is independently a quaternary ammonium group, a phosphonium group, another omnium cation, or any combination thereof; and
wherein R² is defined herein; or 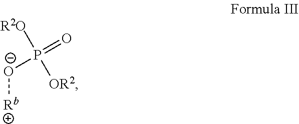
wherein each R² is defined herein; and
wherein solid lines represent covalent bonds and dotted lines represent ionic bonds;
wherein R^{b} comprises a quaternary ammonium group, a phosphonium group, another onium cation, or any combination thereof.

4. The method of claim 1, wherein the phosphorous compound comprises a cationic phosphine compound and an anionic carboxylate having an anionic carboxylate compound having a C₅₋₂₀ alkyl group.

5. The method of claim 1, wherein the phosphorous compound comprises an anionic phosphate and a cationic quaternary ammonium compound.

6. The method of claim 1, wherein the phosphorous compound comprises one or more C₅₋₂₀ alkyl groups covalently bound to a group that is anionic or cationic.

7. The method of claim 1, wherein the phosphorous compound comprises a cation and an anion that are covalently bonded to each other.

8. The method of claim 1, wherein the phosphorous compound comprises a cation and an anion that are ionically bound to each other.

9. The method of claim 1, wherein the one or more carboxylate compounds comprises a carboxylate compound and a counterion that are dissolvable in the polar protic solvent.

10. The method of claim 1, wherein the one or more carboxylate compounds comprise a formula according to a following compound: 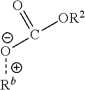
wherein R² and R^{b} are defined herein and dotted line is defined herein.

11. The method of claim 1, wherein the one or more polar protic solvents are present in a mass percent that is greater than about 90 percent, based on a total mass of the solution when beta-lactone monomer and the solution are contacted.

12. The method of claim 1, wherein the one or more polar protic solvents comprise one or more of water, methanol, ethanol, acetic acid, isopropanol, n-butanol, formic acid, or any combination thereof.

13. The method of claim 1, wherein the one or more polar protic solvents comprise water.

14. The method of claim 1, wherein beta-lactone monomer is present in the solution at a mass percent of about 5 percent to about 35 percent based on total mass of the solution when the beta-propiolactone monomer and the solution are contacted.

15. (canceled)

16. (canceled)

17. (canceled)

18. (canceled)

19. The method of claim 1, wherein essentially all of beta-lactone monomer is converted to the polypropiolactone polymer or a side product in about 3 hours or less.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. The method of claim 1, wherein the polypropiolactone polymer has a weight average molecular weight about 1 kg/mol to about 2000 kg/mol.

35. The method of claim 1, wherein the polypropiolactone polymer is substantially free of beta-lactone monomer and/or acrylic acid.

36. (canceled)

37. The method of claim 1, wherein the polypropiolactone polymer has a repeating structure according to following compound: 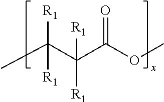
wherein each R¹ is independently selected from one or more of hydrogen, methyl, C₂₋₁₀ alkyl groups, or any combination thereof; and
wherein x is a real number of greater than 1 to 50,000.

38. The method of claim 1, further comprising:
a) contacting carbon monoxide and an epoxide compound to form a beta-lactone monomer.

39. A polymer composition according to claim 1, comprising the polypropiolactone polymer having:
a) Number average molecular weight of about 1000 g/mol to about 200,000 g/mol;
b) PDI of greater than 1 to about 3.5; and
c) side products present in an amount of 50 parts per billion or less.
